(19) United States
(12) Patent Application Publication
(10) Pub. No.: US 2015/0220472 A1
(43) Pub. Date: Aug. 6, 2015

(54) INCREASING THROUGHPUT ON MULTI-WIRE AND MULTI-LANE INTERFACES

(71) Applicant: QUALCOMM Incorporated, San Diego, CA (US)

(72) Inventor: Shoichiro Sengoku, San Diego, CA (US)

(21) Appl. No.: 14/614,188

(22) Filed: Feb. 4, 2015

Related U.S. Application Data
(63) Continuation-in-part of application No. 14/250,119, filed on Apr. 10, 2014.
(60) Provisional application No. 61/935,964, filed on Feb. 5, 2014.
(60) Provisional application No. 61/935,989, filed on Feb. 5, 2014.

(51) Int. Cl. G06F 13/40; G06F 1/08

(52) U.S. Cl. CPC G06F 13/4068; G06F 1/08

(57) ABSTRACT

Systems, methods and apparatus extract data and clocks from a multi-wire bus that includes a first lane operated in accordance with a camera control interface (CCIe) mode of operation or a first lane operated in accordance with an N! mode of operation. Timing information derived from a sequence of symbols received from the first lane may be used to deserialize data received on a second lane of the multi-wire bus or decode a sequence of symbols received on the second lane. The symbols in a pair of consecutive symbols transmitted on the first lane cause different signaling states. Data on the second lane may be deserialized using on the receive clock derived from the timing information. In a CCIe lane, the final symbol of the sequence of symbols may be suppressed or a setup condition curtailed when the final symbol produces a signaling state equivalent to the setup condition.

### CROSS-REFERENCE TO RELATED APPLICATIONS

This application claims priority to and the benefit of Provisional Patent application No. 61/935,964 filed in the U.S. Patent Office on Feb. 5, 2014, Provisional Patent application No. 61/935,989 filed in the U.S. Patent Office on Feb. 5, 2014, and from copending U.S. patent application Ser. No. 14/250,119 filed in the U.S. Patent Office on Apr. 10, 2014, the entire content of which applications are incorporated herein by reference.

### TECHNICAL FIELD

The present disclosure relates generally to an interface between a host processor and a peripheral device such as a camera and, more particularly, to improving data rates, clock recovery and management in multi-lane multi-wire communication interfaces.

### BACKGROUND

Manufacturers of mobile devices, such as cellular phones, may obtain components of the mobile devices from various sources, including different manufacturers. For example, an application processor in a cellular phone may be obtained from a first manufacturer, while the display for the cellular phone may be obtained from a second manufacturer. The application processor and a display or other device may be interconnected using a standards-based or proprietary physical interface. For example, a display may provide an interface that conforms to the Camera Serial Interface standard specified by the Mobile Industry Processor Interface Alliance (MIPI) or the Display System Interface (DSI) standard specified by MIPI.

In one example, a multi-signal data transfer system may employ multi-wire differential signaling such as 3-phase or N-factorial (N!) low-voltage differential signaling (LVDS), transcoding (e.g., the digital-to-digital data conversion of one encoding type to another) may be performed to embed symbol clock information by causing a symbol transition at every symbol cycle, instead of sending clock information in separate data lanes (differential transmission paths). Embedding clock information by transcoding is an effective way to minimize skew between clock and data signals, as well as to eliminate the necessity of a phase-locked loop (PLL) to recover the clock information from the data signals.

In another example, MIPI standards define a camera control interface (CCI) that uses a two-wire, bi-directional, half duplex, serial interface configured as a bus connecting a master and one or more slaves. Conventional CCI is compatible with a protocol used in a variant of the Inter-Integrated Circuit (I2C) bus and is capable of handling multiple slaves on the bus, with a single master. The CCI bus may include Serial Clock (SCL) and Serial Data (SDA) lines. CCI devices and I2C devices can be deployed on the same bus such that two or more CCI devices may communicate using CCI protocols, while any communication involving an I2C bus uses I2C protocols. Later versions of CCI, including CCI extension (CCIe), can provide higher throughputs using modified protocols to support faster signaling rates.

A CCI extension (CCIe) bus may be used to provide higher data rates for devices that are compatible with CCIe bus operations. Such devices may be referred to as CCIe devices, and the CCIe devices can attain higher data rates when communicating with each other by encoding data as symbols transmitted on both the SCL line and the SDA line of a conventional CCI bus. CCIe devices and I2C devices may coexist on the same CCIe bus, such that in a first time interval, data may be transmitted using CCIe encoding and other data may be transmitted in a different time interval according to I2C signaling conventions.

There exists an ongoing need for providing optimized communications on multi-wire communication interfaces.

### SUMMARY

Embodiments disclosed herein provide systems, methods and apparatus that can improve the performance of a camera control interface using a multi-wire bus.

Certain aspects of the disclosure relate to methods of data communications, where the method includes extracting timing information from a first sequence of symbols received from a first lane of a multi-wire bus, decoding the first sequence of symbols using the timing information, and receiving data from a second lane of the multi-wire bus using the timing information. Each pair of consecutive symbols in the sequence of symbols may include symbols that produce different signaling states on the first lane.

In one aspect, a receive clock is generated using the timing information extracted from the first sequence of symbols. The first sequence of symbols may be decoded using the receive clock. A bitstream received from the second lane may be deserialized using the receive clock. Transmissions received from the first and second lanes may be synchronized to a common transmit clock.

In various aspects, the first and second lanes of the multi-wire bus are operated in accordance with CCIe modes of operation. The data may be received from the second lane of the multi-wire bus by using the timing information to receive two-bit symbols from the second lane of the multi-wire bus, and decoding the two-bit symbols received from the second lane of the multi-wire bus in accordance with the timing information. The two-bit symbols received from the second lane of the multi-wire bus may include one or more symbols transmitted during a time period that indicates a start condition on the first lane. Timing information may be extracted from the symbols received from the second lane of the multi-wire bus. A receive clock may be generated using the timing information extracted from the first sequence of symbols and the timing information extracted from the symbols received from the second lane of the multi-wire bus.

In one aspect, the first lane of the multi-wire bus is operated in accordance with a CCIe mode of operation, and the second lane carries a serialized data stream. The data from the second lane of the multi-wire bus may be received by deserializing the serialized data stream in accordance with the timing information and to obtain a plurality of two-bit data elements, and data from the second lane of the multi-wire bus may be provided by assembling the plurality of two-bit data elements. Each symbol in the first sequence of symbols may be transmitted in a symbol interval, and 3 signaling states per symbol interval may be available for encoding data on the first lane of the multi-wire bus, and 4 signaling states per symbol interval may be available for encoding data on the second lane of the multi-wire bus. Receiving the data from the second lane of the multi-wire bus may include using the timing information to receive symbols from the second lane of the multi-wire bus, and decoding the symbols received from the second lane of the multi-wire bus in accordance with the timing information.

In one aspect, the first lane of the multi-wire bus includes N wires, where N>2. N! differential signals representative of voltage differences between each different combination of two wires in the N wires may be provided. The first sequence of symbols may be extracted from the N! differential signals based on the timing information. A first end of each of N resistance elements may be coupled to one of the N wires and second ends of the N resistance elements may be coupled together at a common node. A receive clock may be derived based on the timing information. The receive clock may be used to extract the first sequence of symbols from the N! differential signals. The first sequence of symbols may be decoded and the receive clock used to deserialize data transmitted in a data stream on the second lane.

In one aspect, the second lane of the multi-wire bus includes M wires, where M>2. M! differential signals representative of voltage differences between each different combination of two wires in the M wires may be provided, and a second sequence of symbols may be extracted from the M! differential signals based on the timing information. A first end of each of M resistance elements may be coupled to one of the M wires and second ends of the M resistance elements may be coupled together at a common node. M may or may not be equal in value to N. Boundaries of data decoded from the second lane need not be aligned with boundaries of data decoded from the first lane.

In one aspect, extracting the timing information includes using a clock recovery circuit to derive a receive clock from transitions in signaling state detected on the first lane or the second lane, decoding first received data from the first sequence of symbols, decoding second received data from the second sequence of symbols, and combining the first received data with the second received data to obtain output data.

In one aspect, extracting the timing information includes using a clock recovery circuit to derive a receive clock from transitions in signaling state detected on the first lane or the second lane, combining the first sequence of symbols with the second sequence of symbols to obtain a combined sequence of symbols, and decoding the combined sequence of symbols to obtain output data.

In one aspect, each symbol in the first sequence of symbols may be transmitted in a single symbol interval, N!−1 signaling states per symbol interval may be available for encoding data on the first lane of the multi-wire bus, and M! signaling states per symbol interval are available for encoding data on the second lane of the multi-wire bus.

In another aspect, each symbol in the first sequence of symbols may be transmitted in a single symbol interval, and the first lane and second lane provide a combined (N!+M!−1) signaling states per symbol interval for encoding data.

Certain aspects of the disclosure relate to an apparatus that has a clock recovery circuit configured to generate a receive clock from transitions in signaling state detected on a plurality of connectors of a multi-lane bus, first receiving circuitry adapted to receive first symbols received from a first lane of the multi-lane bus using the receive clock, second receiving circuitry adapted to decode second symbols received from a second lane of the multi-lane bus using the receive clock, or to descrialize data transmitted on the second lane of the multi-lane bus using the receive clock, and a decoder adapted to provide output data by decoding a sequence of symbols received from one or more lanes of the multi-lane bus. Each pair of consecutive symbols in the sequence of symbols may include symbols that produce different signaling states on the multi-lane bus.

Certain aspects of the disclosure relate to an apparatus that includes means for extracting timing information from a first sequence of symbols received from a first lane of a multi-wire bus, means for decoding the first sequence of symbols using the timing information, and means for receiving data from a second lane of the multi-wire bus using the timing information. Each pair of consecutive symbols in the sequence of symbols may include symbols that produce different signaling states on the first lane.

Certain aspects of the disclosure relate to processor-readable storage media. The storage media may include transitory and non-transitory storage media. The storage media may store and/or maintain instructions that, when executed by a processor of a processing circuit, may cause the processing circuit to extract timing information from a first sequence of symbols received from a first lane of a multi-wire bus, decode the first sequence of symbols using the timing information, and receive data from a second lane of the multi-wire bus using the timing information. Each pair of consecutive symbols in the sequence of symbols may include symbols that produce different signaling states on the first lane.

Certain aspects of the disclosure relate to a method of data communications, where the method includes using a clock recovery circuit to derive a receive clock from transitions in signaling state detected on a first lane or a second lane of a multi-wire bus, receiving a first sequence of symbols received from the first lane using the receive clock, and receiving a second sequence of symbols received from the second lane using the receive clock. The first lane may have N wires, where N>2. The second lane may have M wires, where M>2. Encoding ensures that a transition in signaling state occurs on the first lane or second lane between consecutive symbol transmission intervals.

In one aspect, first received data is decoded from the first sequence of symbols, second received data is decoded from the second sequence of symbols, and the first received data is combined with the second received data to obtain output data.

In another aspect, the first sequence of symbols is combined with the second sequence of symbols to obtain a combined sequence of symbols, and the combined sequence of symbols is decoded to obtain output data.

In another aspect, each symbol in the first sequence of symbols is transmitted in a symbol transmission interval. The first lane and second lane may provide a combined (N!+M!−1) signaling states per symbol interval for encoding data.

In another aspect, a first end of each of N resistance elements is coupled to one of the N wires and second ends of the N resistance elements are coupled together at a first common node. Each of M resistance elements may be coupled to one of the M wires and second ends of the M resistance elements are coupled together at a common node.

Certain aspects of the disclosure relate to an apparatus that includes means for deriving a receive clock from transitions in signaling state detected on a first lane or a second lane of a multi-wire bus, where the means for driving the receive clock includes using a clock recovery circuit. The apparatus may also include means for receiving a first sequence of symbols received from the first lane using the receive clock, and means for receiving a second sequence of symbols received from the second lane using the receive clock. The first lane may have N wires, where N>2. The second lane may have M wires, where M>2. Encoding ensures that a transition in signaling state occurs on the first lane or second lane between consecutive symbol transmission intervals.

Certain aspects of the disclosure relate to processor-readable storage media. The storage media may include transitory and non-transitory storage media. The storage media may store and/or maintain instructions that, when executed by a processor of a processing circuit, may cause the processing circuit to use a clock recovery circuit to derive a receive clock from transitions in signaling state detected on a first lane or a second lane of a multi-wire bus, receive a first sequence of symbols received from the first lane using the receive clock, and receive a second sequence of symbols received from the second lane using the receive clock. The first lane may have N wires, where N>2. The second lane may have M wires, where M>2. Encoding ensures that a transition in signaling state occurs on the first lane or second lane between consecutive symbol transmission intervals.

In certain aspects of the disclosure, a method of data communications includes generating a sequence of symbols to be transmitted on a CCIe bus that has two signal wires, determining whether a final symbol in the sequence of symbols is associated with a signaling state on the two wires equivalent to a signaling state produced by a setup condition to be transmitted on the two signal wires after the sequence of symbols is transmitted, and suppressing transmission of the final symbol or curtailing the setup condition when the final symbol is determined to produce the signaling state that is equivalent to the setup condition.

In an aspect of the disclosure, each of the two wires is in a logic high state during transmission of the setup condition.

In an aspect of the disclosure, the CCIe bus is compatible with I2C operation and at least one I2C device is connected to the CCIe bus. At least one I2C device may be connected to the CCIe bus using open-drain transmitters.

In an aspect of the disclosure, the setup condition is transmitted for a period that exceeds a period of time in which the final symbol is transmitted.

In an aspect of the disclosure, the sequence of symbols is transmitted when all of the devices monitoring the CCIe bus use push-pull transmitters when transmitting on the CCIe bus. The sequence of symbols may encode 16 bits of data. Each symbol in the sequence of symbols may be one of four available symbols that define different signaling states of the two wires. Transmission of each symbol in the sequence of symbols may cause a change in signaling state of the two wires with respect to the signaling state of the two wires prior to transmission of the each symbol. The sequence of symbols may encode 3 protocol bits in addition to the 16 bits of data.

In certain aspects of the disclosure, an apparatus includes means for generating a sequence of symbols to be transmitted on a CCIe bus that has two signal wires, means for determining whether a final symbol in the sequence of symbols is associated with a signaling state on the two wires equivalent to a signaling state produced by a setup condition to be transmitted on the two signal wires after the sequence of symbols is transmitted, and means for transmitting the sequence of symbols. The means for transmitting the sequence of symbols may be configured to suppress transmission of the final symbol or curtail the setup condition when the final symbol is determined to produce the signaling state that is equivalent to the setup condition.

In certain aspects of the disclosure, an apparatus includes a plurality of drivers configured for driving a CCIe bus, and a processing circuit configured to generate a sequence of symbols to be transmitted on the CCIe bus that has two signal wires, determine whether a final symbol in the sequence of symbols is associated with a signaling state on the two wires equivalent to a signaling state produced by a setup condition to be transmitted on the two signal wires after the sequence of symbols is transmitted, and suppress transmission of the final symbol or curtail the setup condition when the final symbol is determined to produce the signaling state that is equivalent to the setup condition.

In certain aspects of the disclosure, a processor-readable storage medium stores or maintains one or more instructions. The one or more instructions may be executed by at least one processing circuit, and the instructions may thereby cause the at least one processing circuit to generate a sequence of symbols to be transmitted on a CCIe bus that has two signal wires, determine whether a final symbol in the sequence of symbols is associated with a signaling state on the two wires equivalent to a signaling state produced by a setup condition to be transmitted on the two signal wires after the sequence of symbols is transmitted, and suppress transmission of the final symbol or curtail the setup condition when the final symbol is determined to produce the signaling state that is equivalent to the setup condition.

In certain aspects of the disclosure, a method of data communications, includes encoding a first data element into a number of first symbols, transmitting the first symbols in a first transmission interval on a corresponding number of lanes of a multi-lane communication link, encoding a second data element into a number of second symbols, and transmitting the second symbols in a second transmission interval on the corresponding number of lanes of the multi-lane communication link. The first data element and second data element may each include two or more bits. A transition in signaling state of the multi-lane communication link may occur between the first transmission interval and the second transmission interval. The first data element and the second data element may be parts of a same data word. In one example, the first data element and the second data element comprise different 16-bit words, there are seven 3! lanes, and there are 7 first symbols and 7 second symbols. In another example, the first data element and the second data element comprise different 9-bit words, there are two 4! lanes, and there are 2 first symbols and 2 second symbols.

In certain aspects of the disclosure, an apparatus includes means for encoding a first data element into a number of first symbols, means for transmitting the first symbols in a first transmission interval on a corresponding number of lanes of a multi-lane communication link, means for encoding a second data element into a number of second symbols, and means for transmitting the second symbols in a second transmission interval on the corresponding number of lanes of the multi-lane communication link. The first data element may include two or more bits the second data element may include two or more bits. A transition in signaling state of the multi-lane communication link may occur between the first transmission interval and the second transmission interval. The first data element and the second data element may be parts of a same data word. In one example, the first data element and the second data element comprise different 16-bit words, there are seven 3! lanes, and there are 7 first symbols and 7 second symbols. In another example, the first data element and the second data element comprise different 9-bit words, there are two 4! lanes, and there are 2 first symbols and 2 second symbols.

Certain aspects of the disclosure relate to processor-readable storage media. The storage media may include transitory and non-transitory storage media. The storage media may store and/or maintain instructions that, when executed by a processor of a processing circuit, may cause the processing circuit to encode a first data element into a number of first symbols, transmit the first symbols in a first transmission interval on a corresponding number of lanes of a multi-lane communication link, encode a second data element into a number of second symbols, and transmit the second symbols in a second transmission interval on the corresponding number of lanes of the multi-lane communication link. The first data element may include two or more bits the second data element may include two or more bits. A transition in signaling state of the multi-lane communication link may occur between the first transmission interval and the second transmission interval. The first data element and the second data element may be parts of a same data word. In one example, the first data element and the second data element comprise different 16-bit words, there are seven 3! lanes, and there are 7 first symbols and 7 second symbols. In another example, the first data element and the second data element comprise different 9-bit words, there are two 4! lanes, and there are 2 first symbols and 2 second symbols.

### BRIEF DESCRIPTION OF THE DRAWINGS

FIG. 1 depicts an apparatus employing a data link between IC devices that selectively operates according to one of plurality of available standards.

FIG. 2 illustrates a system architecture for an apparatus employing a data link between IC devices.

FIG. 3 illustrates a CDR circuit that may be used in an N! communication interface.

FIG. 4 illustrates timing of certain signals generated by the CDR circuit of FIG. 3 in accordance with one or more aspects disclosed herein.

FIG. 5 illustrates an example of a basic N! multi-lane interface.

FIG. 6 illustrates a first example of a multi-lane interface provided according to one or more aspects disclosed herein.

FIG. 7 illustrates a second example of a multi-lane interface provided according to one or more aspects disclosed herein.

FIG. 8 illustrates a third example of a multi-lane interface provided according to one or more aspects disclosed herein.

FIG. 9 illustrates a fourth example of a multi-lane interface provided according to one or more aspects disclosed herein.

FIG. 10 illustrates a fifth example of a multi-lane interface provided according to one or more aspects disclosed herein.

FIG. 11 is a timing diagram illustrating the ordering of data transmitted on a multi-lane interface provided according to one or more aspects disclosed herein.

FIG. 12 illustrates a fifth example of a multi-lane interface provided according to one or more aspects disclosed herein.

FIG. 13 illustrates a system architecture for an apparatus employing a CCIe bus between IC devices.

FIG. 14 illustrates certain aspects of a transmitter and a receiver in a CCIe device according to certain aspects disclosed herein.

FIG. 15 illustrates an encoding scheme for transcoding data to be transmitted over a CCIe bus in accordance with certain aspects disclosed herein.

FIG. 16 illustrates an example of a clock and data recovery circuit adapted for use in a CCIe device according to one or more aspects disclosed herein.

FIG. 17 illustrates timing of certain signals generated by the clock and data recovery circuit illustrated in FIG. 16.

FIG. 18 illustrates a device configured for communication over a multi-lane CCIe bus.

FIG. 19 illustrates a first example of transmitters and receivers in a pair of devices configured for communication over a multi-lane CCIe bus.

FIG. 20 illustrates a second example of transmitters and receivers in a pair of devices configured for communication over a multi-lane CCIe bus.

FIG. 21 illustrates an example of data transmissions on a CCIe bus configured to support co-existence with I2C devices on the same bus.

FIG. 22 illustrates an example of data transmissions on a CCIe bus when no I2C devices are connected or monitoring the CCIe bus.

FIG. 23 illustrates the effect on setup timing of four possible final symbols in a sequence of symbols transmitted on the CCIe bus.

FIG. 24 illustrates a method for improving data rates transmitted over a CCIe bus according to one or more aspects disclosed herein.

FIG. 25 is a block diagram illustrating a first example of an apparatus employing a processing circuit that may be adapted according to certain aspects disclosed herein.

FIG. 26 is a first flow chart, which illustrates a method for communicating on a multi-lane, multi-wire bus according to one or more aspects disclosed herein.

FIG. 27 is a second flow chart, which illustrates a method for communicating on a multi-lane, multi-wire bus according to one or more aspects disclosed herein.

FIG. 28 illustrates a first example of a hardware implementation for an apparatus, where the apparatus may be used for communication over a multi-lane communication link bus according to one or more aspects disclosed herein.

FIG. 29 is a third flow chart, which illustrates a method for communicating on a CCIe bus according to one or more aspects disclosed herein.

FIG. 30 illustrates a third example of a hardware implementation for an apparatus, where the apparatus may be used for communication over a CCIe bus according to one or more aspects disclosed herein.

FIG. 31 is a fourth flow chart, which illustrates a method for communicating on a multi-lane, multi-wire bus according to one or more aspects disclosed herein.

FIG. 32 illustrates a third example of a hardware implementation for an apparatus, where the apparatus may be used for communication over a multi-lane communication link bus according to one or more aspects disclosed herein.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more exemplary embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), and floppy disk where disks usually reproduce data magnetically, while discs reproduce data optically with lasers. Combinations of the above should also be included within the scope of computer-readable media.

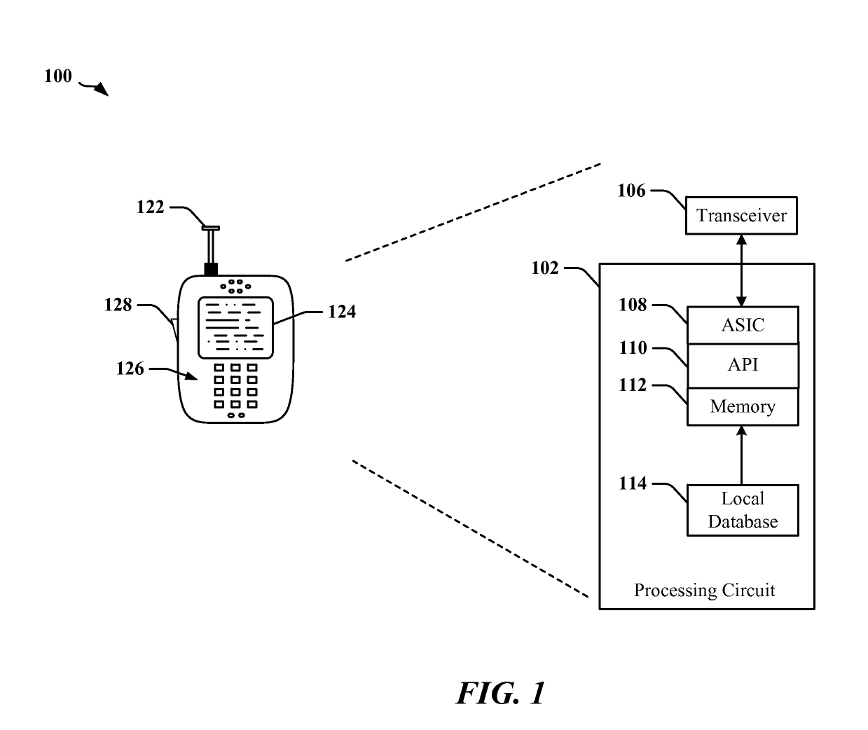

Certain aspects of the invention may be applicable to communications links deployed between electronic devices that may include subcomponents of an apparatus such as a telephone, a mobile computing device, an appliance, automobile electronics, avionics systems, etc. FIG. 1 depicts an apparatus that may employ a communication link between IC devices. In one example, the apparatus 100 may include a wireless communication device that communicates through an RF transceiver with a radio access network (RAN), a core access network, the Internet and/or another network. The apparatus 100 may include a communications transceiver 106 operably coupled to processing circuit 102. The processing circuit 102 may include one or more IC devices, such as an application-specific IC (ASIC) 108. The ASIC 108 may include one or more processing devices, logic circuits, and so on. The processing circuit 102 may include and/or be coupled to processor readable storage such as a memory 112 that may maintain instructions and data that may be executed by processing circuit 102. The processing circuit 102 may be controlled by one or more of an operating system and an application programming interface (API) 110 layer that supports and enables execution of software modules residing in storage media, such as the memory device 112 of the wireless device. The memory device 112 may include read-only memory (ROM) or random-access memory (RAM), electrically erasable programmable ROM (EEPROM), flash cards, or any memory device that can be used in processing systems and computing platforms. The processing circuit 102 may include or access a local database 114 that can maintain operational parameters and other information used to configure and operate the apparatus 100. The local database 114 may be implemented using one or more of a database module, flash memory, magnetic media, EEPROM, optical media, tape, soft or hard disk, or the like. The processing circuit may also be operably coupled to external devices such as an antenna 122, a display 124, operator controls, such as button 128 and keypad 126 among other components.

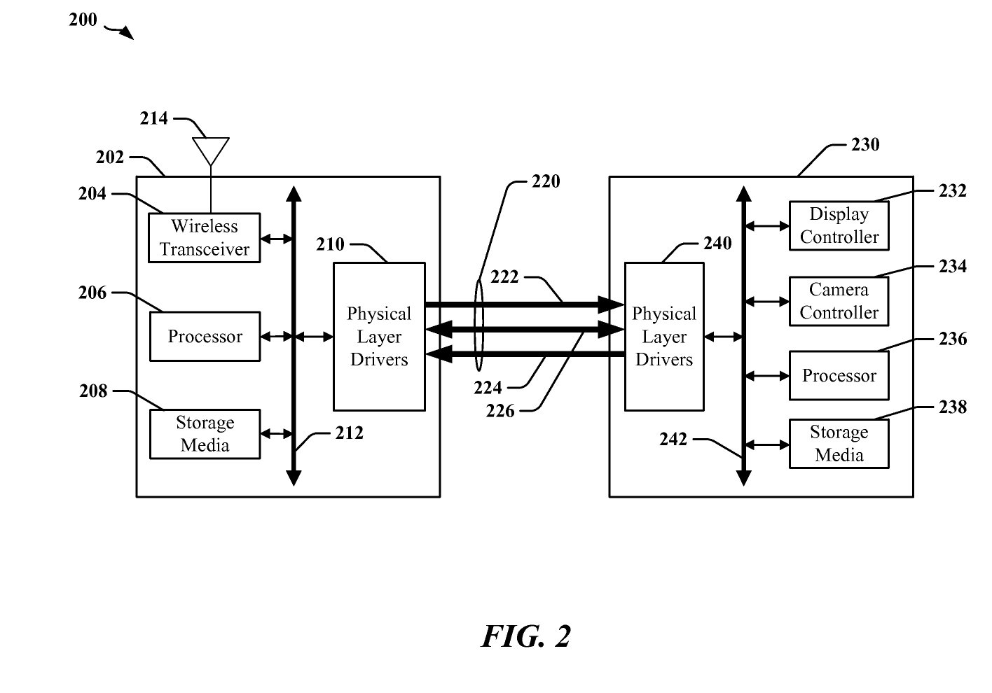

FIG. 2 is a block schematic 200 illustrating certain aspects of an apparatus 200 connected to a communications bus, where the apparatus 200 may be embodied in one or more of a wireless mobile device, a mobile telephone, a mobile computing system, a wireless telephone, a notebook computer, a tablet computing device, a media player, a wearable computing device, an appliance, a gaming device, or the like. The apparatus 200 may include a plurality of IC devices 202 and 230 that exchange data and control information through a communication link 220. The communication link 220 may be used to connect IC devices 202 and 222 that are located in close proximity to one another, or physically located in different parts of the apparatus 200. In one example, the communication link 220 may be provided on a chip carrier, substrate or circuit board that carries the IC devices 202 and 230. In another example, a first IC device 202 may be located in a keypad section of a flip-phone while a second IC device 230 may be located in a display section of the flip-phone. In another example, a portion of the communication link 220 may include a cable or optical connection.

The communication link 220 may include multiple channels 222, 224 and 226. One or more channels 226 may be bidirectional, and may operate in half-duplex and/or full-duplex modes. One or more channels 222 and 224 may be unidirectional. The communication link 220 may be asymmetrical, providing higher bandwidth in one direction. In one example described herein, a first communications channel 222 may be referred to as a forward link 222 while a second communications channel 224 may be referred to as a reverse link 224. The first IC device 202 may be designated as a host system or transmitter, while the second IC device 230 may be designated as a client system or receiver, even if both IC devices 202 and 230 are configured to transmit and receive on the communications link 222. In one example, the forward link 222 may operate at a higher data rate when communicating data from a first IC device 202 to a second IC device 230, while the reverse link 224 may operate at a lower data rate when communicating data from the second IC device 230 to the first IC device 202.

The IC devices 202 and 230 may each have a processor or other processing and/or computing circuit or device 206, 236. In one example, the first IC device 202 may perform core functions of the apparatus 200, including maintaining wireless communications through a wireless transceiver 204 and an antenna 214, while the second IC device 230 may support a user interface that manages or operates a display controller 232. The first IC device 202 or second IC device 230 may control operations of a camera or video input device using a camera controller 234. Other features supported by one or more of the IC devices 202 and 230 may include a keyboard, a voice-recognition component, and other input or output devices. The display controller 232 may include circuits and software drivers that support displays such as a liquid crystal display (LCD) panel, touch-screen display, indicators and so on. The storage media 208 and 238 may include transitory and/or non-transitory storage devices adapted to maintain instructions and data used by respective processors 206 and 236, and/or other components of the IC devices 202 and 230. Communication between each processor 206, 236 and its corresponding storage media 208 and 238 and other modules and circuits may be facilitated by one or more bus 212 and 242, respectively.

The reverse link 224 may be operated in the same manner as the forward link 222, and the forward link 222 and reverse link 224 may be capable of transmitting at comparable speeds or at different speeds, where speed may be expressed as data transfer rate and/or clocking rates. The forward and reverse data rates may be substantially the same or differ by orders of magnitude, depending on the application. In some applications, a single bidirectional link 226 may support communications between the first IC device 202 and the second IC device 230. The forward link 222 and/or reverse link 224 may be configurable to operate in a bidirectional mode when, for example, the forward and reverse links 222 and 224 share the same physical connections and operate in a half-duplex manner. In one example, the communication link 220 may be operated to communicate control, command and other information between the first IC device 202 and the second IC device 230 in accordance with an industry or other standard.

In one example, forward and reverse links 222 and 224 may be configured or adapted to support a wide video graphics array (WVGA) 80 frames per second LCD driver IC without a frame buffer, delivering pixel data at 810 Mbps for display refresh. In another example, forward and reverse links 222 and 224 may be configured or adapted to enable communications between with dynamic random access memory (DRAM), such as double data rate synchronous dynamic random access memory (SDRAM). Encoding devices 210 and/or 230 can encode multiple bits per clock transition, and multiple sets of wires can be used to transmit and receive data from the SDRAM, control signals, address signals, and so on.

The forward and reverse links 222 and 224 may comply or be compatible with application-specific industry standards. In one example, the MIPI standard defines physical layer interfaces between an application processor IC device 202 and an IC device 230 that supports the camera or display in a mobile device. The MIPI standard includes specifications that govern the operational characteristics of products that comply with MIPI specifications for mobile devices. The MIPI standard may define interfaces that employ complimentary metal-oxide-semiconductor (CMOS) parallel busses.

In one example, the communication link 220 of FIG. 2 may be implemented as a wired bus that includes a plurality of signal wires (denoted as N wires). The N wires may be configured to carry data encoded in symbols, where clock information is embedded in a sequence of the symbols transmitted over the plurality of wires.

### Clock Recovery in Multi-Wire Communications Links

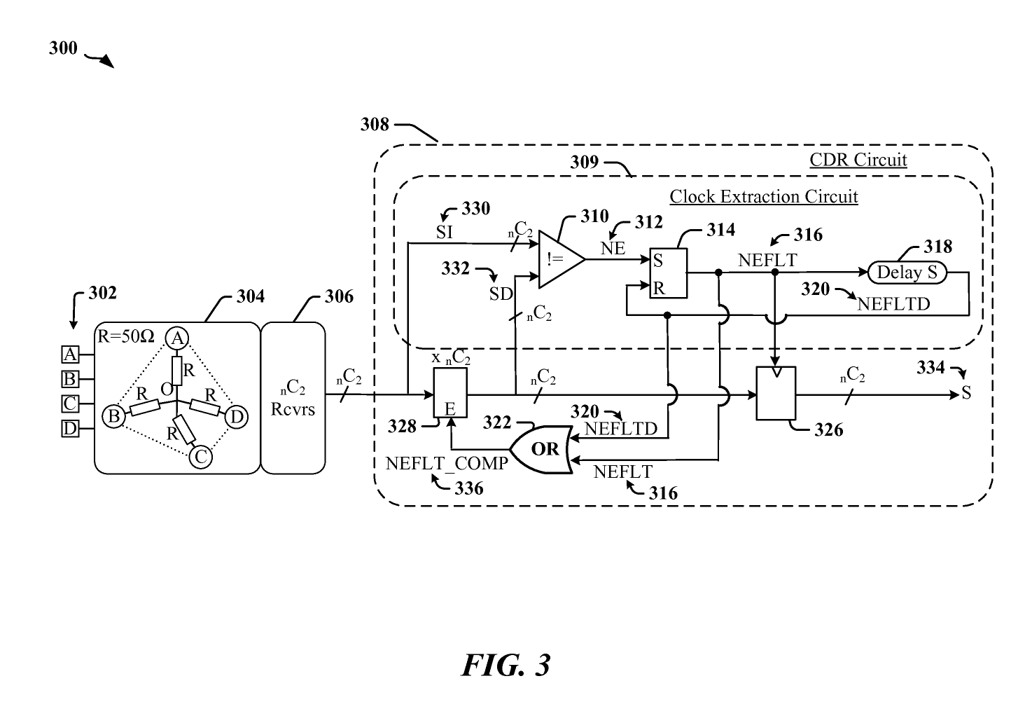

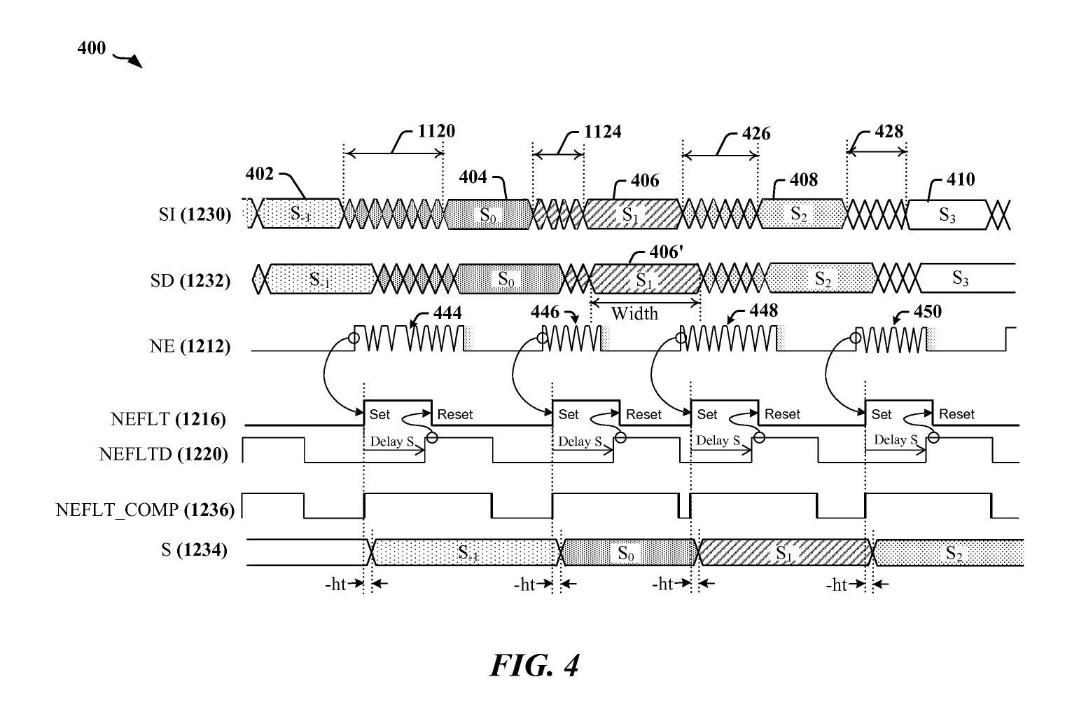

FIG. 3 is a block diagram of a receiver circuit 300 that includes of one example of a clock and data recovery (CDR) circuit 308 that illustrates certain aspects of clock and data recovery from a multi-wire interface. The CDR circuit 308 may be employed to recover embedded clock information in an N-wire system. FIG. 4 is a timing diagram 400 illustrating certain signals generated through the operation of the CDR circuit 308. The CDR circuit 308 and its timing diagram 400 are provided by way of generalized example, although other variants of the CDR circuit 308 and/or other CDR circuits may be used in some instances. Signals received from N-wires 302 are initially processed by a number (_{N}C₂) of receivers 306, which produce a corresponding number of raw signals as outputs. In the illustrated example, N=4 wires 302 are processed by ₄C₂=6 receivers 306 that produce a first state transition signal (SI signal) 330 that includes 6 raw signals representative of the received symbol.

The CDR circuit 308 may be used with a variety of multi-wire interfaces, including interfaces that use N! encoding, N-phase encoding, and other encoding schemes that use symbol transition clocking, including interfaces that employ single-ended multi-wire communication links.

A receiver circuit 300 may include an N-wire termination network 304, a plurality of receivers 306, and a clock data recovery circuit 308. In the illustrated example, a clock is embedded in symbol transitions within a spread signal received across four wires or conductors 302. The spread signal may be defined by a plurality of transition signals including a first signal over a first line interface, conductor, or wire. The CDR circuit 308 may be configured to extract a clock and data symbols from the spread signal received over the four wires or conductors 302. The CDR circuit 308 may include a comparator 310, a set-reset latch 314, a first analog delay device S 318, and a level latch 328. A clock extraction circuit 309 may be defined by the comparator 310, a set-reset latch 314, and a first analog delay device S 318. The clock extraction circuit 309 may be adapted to extract a signal that may be used to obtain a clock signal from signals. The clock signal may be obtained using jitter compensation and serves to sample symbols from state transition in the spread signal received over the plurality of receivers 306.

The comparator 310 may compare a first instance of the first signal (SI) 330 and a delayed second instance of the first signal (SD) 332, and the comparator 310 outputs a comparison signal (NE signal) 312. The set-reset latch 314 may receive the NE signal 312 from the comparator 310 and provides a filtered version of the comparison signal (NEFLT signal) 316. The first analog delay device S 318 receives the NEFLT signal 316 and outputs a delayed instance of the NEFLT signal 316 as the NEFLTD signal 320. The NEFLTD signal 320 serves as the reset input to the set-reset latch 314 such that the output of the set-reset latch 314 is reset after a delay S. In one example, the NEFLT signal 316 may be used as the clock signal to sample symbols.

Various elements illustrated in the CDR circuit 308 may be implemented by various sub-circuits. For example, the set-reset latch 314 may be implemented as a first logic circuit, the analog delay S device 318 may be implemented as a series of inverters, and the comparator 310 may be implemented as a second logic circuit.

In one example, the spread signal distributed across the wires or conductors 302 may include a plurality of distinct transition signals, which in combination carry symbols with guaranteed symbol-to-symbol state transitions between consecutive symbols. For example, in an example of three conductors (A, B, C) configured for differential signaling in accordance with certain aspects disclosed herein, the spread signal may be defined by the combination of the differential signals between conductors A and B, the differential signals between conductors B and C, and the differential signals between conductors C and A.

A level latch 328 receives the first instance of the first signal (SI) 330 and provides the delayed second instance of the first signal (SD) 332. The level latch 328 is triggered by the resulting output NEFLT_COMP 336 of an OR gate 322 which has the NEFLT 316 and NEFLTD signal 320 as inputs.

A level latch 328 receives the first instance of the first signal (SI) 330 and provides the delayed second instance of the first signal (SD) 332 to the comparator 310. The level latch 328 is triggered by a delayed instance of the NE signal 312. A flip-flop device 326 may also receive the delayed second instance of the first signal (SD) 332 and outputs a symbol (S) 334 triggered by the NEFLT signal 316. That is, the flip-flop device 326 is triggered by a rising edge on the NEFLT signal 316. Consequently, the level latch 328 serves to generate the NE signal 312. In turn, the NE signal 312 serves to generate the NEFLT signal 316 which serves as a latching clock for the flip-flop device 326.

In operation, when a transition occurs between a current symbol (S₀) 404 and a next symbol (S₁) 406, the state of the SI signal 330 begins to change. The NE signal 312 transitions high when the comparator 310 first detects a difference between the SI signal 330 and the SD signal 332, causing the set-reset latch 314 to be asynchronously set. Accordingly, the NEFLT signal 316 transitions high, and this high state is maintained until the set-reset latch 314 is reset when the NEFLTD signal 320 becomes high. The NEFLT signal 316 transitions to a high state in response to the rising edge of the NE signal 312, and the NEFLT signal 316 transitions to a low state in response to the rising edge of the NEFLTD signal 320 after a delay attributable to the first analog delay device S 318.

As transitions between symbols 402, 404, 406, 408, and 410 occur, one or more intermediate or indeterminate states 420, 424, 426, 428 may occur on the SI signal 330 due to inter-wire skew, signal overshoot, signal undershoot, crosstalk, and so on. The intermediate states on the SI signal 330 may be regarded as invalid data, and these intermediate states may cause spikes 444, 446, 448, and 450 in the NE signal 312 as the output of the comparator 310 returns towards a low state for short periods of time. The spikes 444, 446, 448, and 450 do not affect the NEFLT signal 316 output by the set-reset latch 314. The set-reset latch 314 effectively blocks and/or filters out the spikes 444, 446, 448, and 450 on the NE signal 312 from the NEFLT signal 316.

The flip-flop device 326 may have a negative hold time (−ht) as the input symbols 402, 404, 406, 408, and 410 in the SI signal 330 can change prior to the symbol being latched or captured by the flip-flop device 326. For instance, each symbol 402′, 404′, 406′ and 408′ in the SD signal 332 is set or captured by the flip-flop device 326 at the rising clock edge of the NEFLT signal 316, which occurs after the input symbols 402, 404, 406, 408, and 410 have changed in the SI signal 330.

The CDR circuit 308 illustrated in FIG. 3 can achieve minimum delay while guaranteeing to sample valid data in order to output symbol (S) 334. By triggering the level latch 328 using a delayed version of the NE signal (signal NEFLT_COMP 336), a stable version of the delayed second instance of the first signal (SD signal 332) can be latched in more quickly, resulting in a stable wider symbol. The optimized width of the stable symbol portion of the SD signal 332 can provide a wider sampling margin such that the speed of the transmission link may be maximized.

### Multi-Lane N! Communications Links

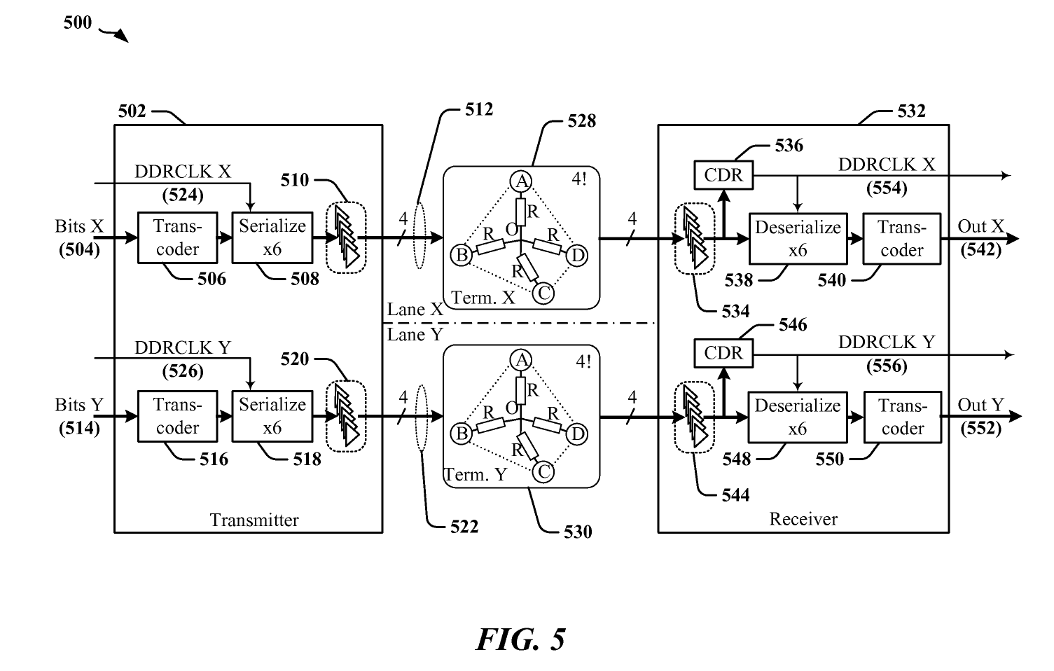

FIG. 5 is a diagram illustrating one example of a multi-lane interface 500 provided between two devices 502 and 532. At a transmitter 502, transcoders 506, 516 may be used to encode data 504, 514 and clock information in symbols to be transmitted over a set of N wires on each lane 512, 522, using N-factorial (N!) encoding for example. The clock information is derived from respective transmit clocks 524, 526 and may be encoded in a sequence of symbols transmitted in _{N}C₂ differential signals over the N wires by ensuring that a signaling state transition occurs on at least one of the _{N}C₂ signals between consecutive symbols. When N! encoding is used to drive the N wires, each bit of a symbol is transmitted as a differential signal by one of a set of line drivers 510, 520, where the differential drivers in the set of line drivers 510, 520 are coupled to different pairs of the N wires. The number of available combinations of wire pairs and signals may be calculated to be _{N}C₂, and the number of available combinations determines the number of signals that can be transmitted over the N wires. The number of data bits 504, 514 that can be encoded in a symbol may be calculated based on the number of available signaling states available for each symbol transmission interval.

A termination impedance (typically resistive) couples each of the N wires to a common center point in a termination network 528, 530. It will be appreciated that the signaling states of the N wires reflects a combination of the currents in the termination network 528, 530 attributed to the differential drivers 510, 520 coupled to each wire. It will be further appreciated that the center point of the termination network 528, 530 is a null point, whereby the currents in the termination network 528, 530 cancel each other at the center point.

The N! encoding scheme need not use a separate clock channel and/or non-return-to-zero decoding because at least one of the _{N}C₂ signals in the link transitions between consecutive symbols. Effectively, each transcoder 506, 516 ensures that a transition occurs between each pair of symbols transmitted on the N wires by producing a sequence of symbols in which each symbol is different from its immediate predecessor symbol. In the example depicted in FIG. 5, each lane 512, 522 has N=4 wires and each set of 4 wires can carry ₄C₂=6 differential signals. The transcoder 506, 516 may employ a mapping scheme to generate raw symbols for transmission on the N wires available on a lane 512, 522. The transcoder 506, 516 and serializer 508, 518 cooperate to produce raw symbols for transmission based on the input data bits 504, 514. At the receiver 532, a transcoder 540, 550 may employ a mapping to determine a transition number that characterizes a difference between a pair of consecutive raw symbols, symbols in a lookup table, for example. The transcoders 506, 516, 540, 550 operate on the basis that every consecutive pair of raw symbols includes two different symbols.

The transcoder 506, 516 at the transmitter 502 may select between the N!−1 states that are available at every symbol transition. In one example, a 4! system provides 4!−1=23 signaling states for the next symbol to be transmitted at each symbol transition. The bit rate may be calculated as log₂ (available_states) per cycle of the transmit clock 524, 526. In a system using double data rate (DDR) clocking, symbol transitions occur at both the rising edge and falling edge of the transmit clock 524, 526. In one example, two symbols can be transmitted per word (i.e. per transmit clock cycle), such that the total available states in the transmit clock cycle is (4!−1)²=(23)²=529 and the number of data bits 304 that can transmitted per symbol may be calculated as log₂ (529)=9.047 bits.

A receiving device 532 receives the sequence of symbols using a set of line receivers 534, 544, where each receiver in the set of line receivers 534, 544 determines differences in signaling states on one pair of the N wires. Accordingly, _{N}C₂ receivers are used in each lane 512, 522, where N represents the number of wires in the corresponding lane 512, 522. The _{N}C₂ receivers 534, 544 produce a corresponding number of raw symbols as outputs.

In the depicted example, each lane 512, 522 has N=4 wires and the signals received on the four wires of each lane 512, 522 are processed by a corresponding set of line receivers 534 or 544 that includes 6 receivers (₄C₂=6) to produce a state transition signal that is provided to a corresponding CDR 536, 546 and deserializer 538, 548. The CDRs 536 and 546 may operate in generally the same manner as the CDR 300 of FIG. 3 and each CDR 536 and 546 may produce a receive clock signal 554, 556 that can be used by a corresponding deserializer 538, 548. The clock signal 554, 556 may include a DDR clock signal that can be used by external circuitry to receive data provided by the transcoders 540, 550. Each transcoder 540, 550 decodes a block of received symbols from the corresponding deserializer 538, 548 by comparing each next symbol to its immediate predecessor. The transcoders 540, 550 produce output data 542 and 552 that corresponds to the data 504, 514 provided to the transmitter 502.

As illustrated in the example of FIG. 5, each lane 512, 522 may be operated independently, although in a typical application the data 504 transmitted over one lane 512 may be synchronized with the data 514 transmitted over another lane 522. In one example, data bits 504 for transmission over a first lane (in this example, Lane X) 512 are received by a first transcoder 506 which generates a set of raw symbols, which may be transmitted in a predetermined sequence that ensures that a transition of signaling state occurs in at least one signal transmitted on the 4 wires of the first lane 512. A serializer 508 produces a sequence of symbol values provided to line drivers 510 that determine the signaling state of the 4 wires of the first lane 512 for each symbol interval. Concurrently, data bits 514 are received by a second transcoder 516 of a second lane (in this example, Lane Y) 522. The second transcoder 516 generates a set of transition numbers that are serialized by a serializer 518 that converts the set of transition numbers to a sequence of symbol values provided to line drivers 520 that determine the signaling state of the 4 wires of the second lane 522 for each symbol interval. The sequence of the raw symbols ensure that a transition of signaling state occurs in at least one signal transmitted on the 4 wires of the second lane 522 between each pair of consecutive symbols.

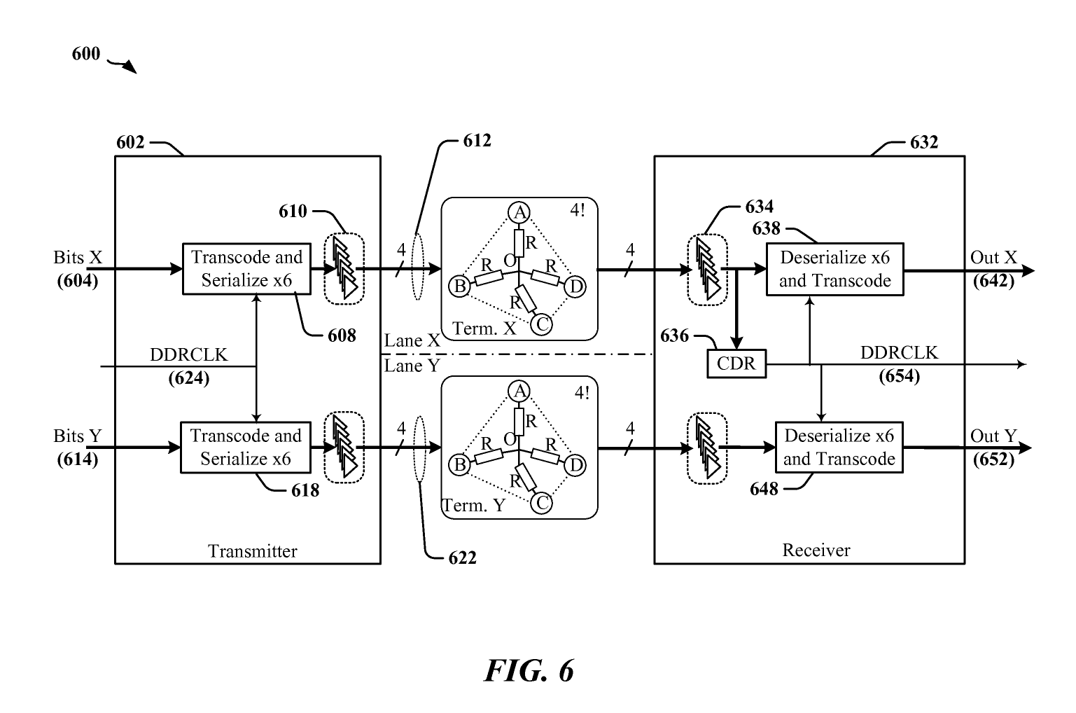

FIG. 6 illustrates a first example of a multi-lane interface 600 provided according to certain aspects disclosed herein. The multi-lane interface 600 offers improved data throughput and reduced circuit complexity when clock information encoded in symbols transmitted on a first lane (here Lane X) 612 is used by a receiver to receive symbols transmitted without encoded clock information on one or more other lanes, including Lane Y 622. In the example depicted, each lane 612, 622 includes 4 wires.

Data for transmission may be divided into two portions 604 and 614, where each portion is transmitted on a different lane 612, 622. On a first lane 612, data 604 and information related to the transmit clock 624 may be encoded using the transcoder/serializer 608 to obtain raw symbols that are serialized as described in relation to FIG. 5. At the receiver 632, the output of receivers 634 associated with the first lane 612 is provided to a CDR 636. The CDR 636 may be configured to detect transitions in signaling state in order to generate a receive clock 654 used by both deserializing and transcoding circuits 638 and 648 for both lanes 612, 622. First deserializing and transcoding circuits 638 extract data 642 from the raw symbols received from the first lane 612, while second deserializing and transcoding circuits 648 extract data 652 from the raw symbols received from the second lane 622.

For the second lane 622, transmission data 614 may be provided to transcoding and serializing circuits 618 and transmitted on the second lane 622 without encoded clock information. The transcoding circuitry used to produce raw symbols for the second lane 622 may be significantly less complex than the transcoding circuitry used to produce raw symbols with embedded clock information for transmission on the first lane 612. For example, transcoding circuits for the second lane 622 may not need to perform certain arithmetic operations and logic functions to guarantee state transition at every symbol boundary.

In the example depicted in FIG. 6, a DDR clocked 4-wire first lane 612 provides (4!−1)²=(23)²=529 signaling states per two symbol words, and can encode log₂ 529=9.047 bits of data per two symbol words, while the DDR clocked 4-wire second lane 622 provides (4!)²=(24)²=576 signaling states per two symbol words and can encode log₂ 576=9.170 bits of data per two symbol words.

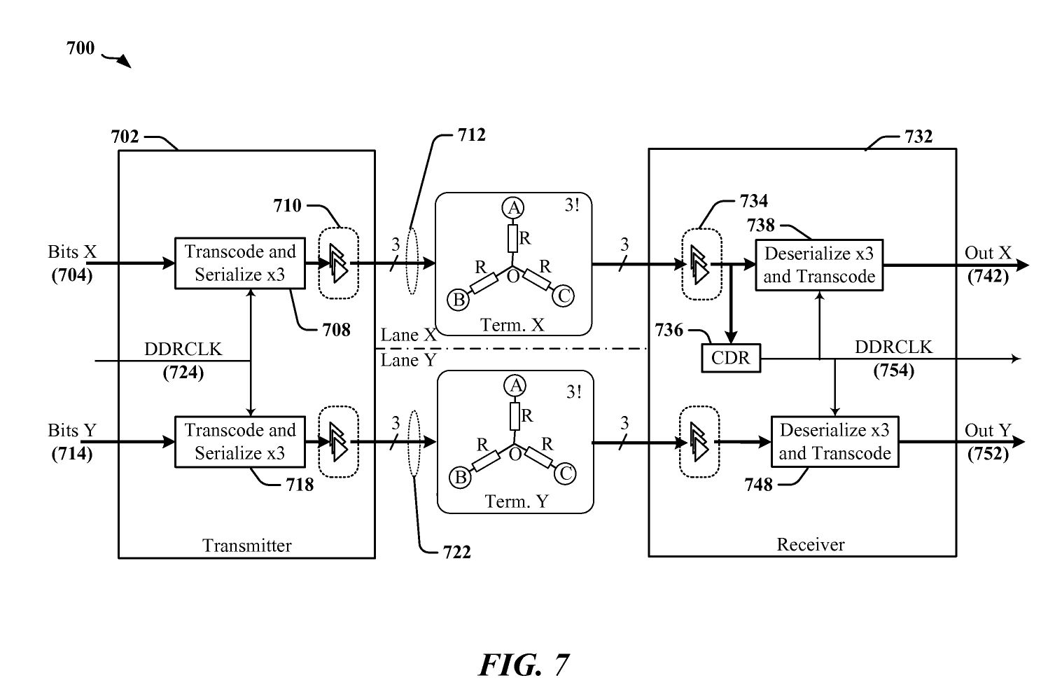

FIG. 7 illustrates a second example of a multi-lane interface 700 provided according to certain aspects disclosed herein. In this multi-lane interface 700 clock information encoded in symbols transmitted on a first lane (here Lane X) 712 may be used by a receiver to receive symbols transmitted without encoded clock information on one or more other lanes, including Lane Y 722. In this example, each lane 712, 722 includes 3 wires.

Data for transmission may be divided into two portions 704 and 714, where each portion is transmitted on a different lane 712, 722. On a first lane 712, data 704 and information related to the transmit clock 724 may be encoded using the transcoder/serializer 708 to obtain raw symbols that are serialized as described in relation to FIG. 5. At the receiver circuit 732, the output of receivers 734 associated with the first lane 712 is provided to a CDR 736. The CDR 736 may be configured to detect transitions in signaling state in order to generate a receive clock 754 used by both deserializing and transcoding circuits 738 and 748 for both lanes 712, 722. First deserializing and transcoding circuits 738 extract data 742 from the raw symbols received from the first lane 712, while second descrializing and transcoding circuits 748 extract data 752 from the raw symbols received from the second lane 722.

For the second lane 722, transmission data 714 may be provided to transcoding and serializing circuits 718 and transmitted on the second lane 722 without encoded clock information. The transcoding circuitry used to produce raw symbols for the second lane 722 may be significantly less complex than the transcoding circuitry used to produce raw symbols with embedded clock information for transmission on the first lane 712. For example, transcoding circuits for the second lane 722 may not need to perform certain arithmetic operations and logic functions to guarantee state transition at every symbol boundary.

In the example depicted in FIG. 7, a DDR clocked 3-wire first lane 712 provides (3!−1)²=(5)²=25 signaling states per two symbol words, and can encode log₂ 25=4.644 bits of data per word received 704, 714, while DDR clocked 3-wire second lane 722 provides (3!)²=(6)²=36 signaling states per two symbol words and can encode log₂ 36=5.170 bits of data per two symbol words. Accordingly, in an interface having two 3-wire lanes where clock information is encoded in the first lane but not in the second lane, 7 symbols may be transmitted per word and the 3-wire first lane provides (3!−1)⁷=(5)⁷=78125 signaling states and can encode log₂ 78125=16.253 bits of data per word, while the 3-wire second lane provides (3!)⁷=6⁷=279936 signaling states and can encode log₂ 279936=18.095 bits of data in each clock cycle. By encoding clock information in a single lane of a multi-lane N!, a higher overall throughput can be accomplished with less hardware.

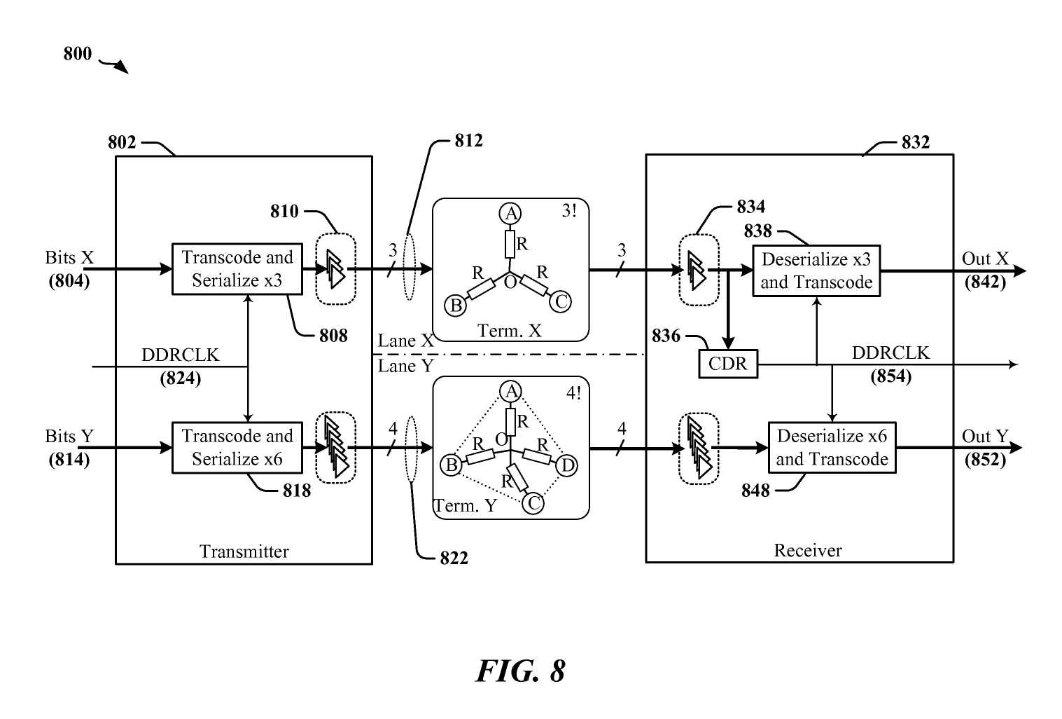

FIG. 8 illustrates another example of a multi-lane interface 800 provided in accordance with one or more aspects disclosed herein. The multi-lane interface 800 offers improved flexibility of design in addition to optimized data throughput and reduced circuit complexity. Here clock information encoded in the symbols transmitted on one lane (here Lane X) 812 may be used to receive symbols transmitted on one or more other lanes 822 that have different numbers of wires.

In the depicted example, data for transmission may be divided into a plurality of portions 804 and 814, where each portion is to be transmitted on a different lane 812, 822. On a first lane 812, data 804 and a transmit clock 824 may be converted by transcoding and serializing circuits 808 to obtain a sequence of raw symbols as described in relation to FIGS. 5, 6 and 7. On a second lane 822, the received data 814 may be provided to transcoding and serializing circuits 818 and then transmitted without embedded clock information.

At the receiver 832, the output of receivers 834 associated with the first lane 812 is provided to a CDR 836. The CDR 836 may be configured to detect a transition in signaling state of the 3 wires in the first lane 812, and to generate a receive clock 854 used by both deserializing and transcoding circuits 838 and 848 for both lanes 812, 822. First deserializing and transcoding circuits 838 extract data 842 from the raw symbols received from the first lane 812, while second deserializing and transcoding circuits 848 extract data 852 from the raw symbols received from the second lane 822.

In the example, the first lane 812 includes 3 wires configured for 3! operation, while the second lane 822 includes 4 wires configured for 4! operation. The first lane 812 can provide (3!−1)²=(5)²=25 signaling states for a 2 symbol per word system, whereby log₂ 25=4.644 bits of data can be encoded per word. The 4-wire second lane 822 provides (4!)²=(24)²=576 signaling states and can encode log₂ 576=9.170 bits of data per word.

The number of symbols per word may be selected to obtain a desired efficiency of encoding for a given application. In the example depicted in FIG. 8, transcoding may be performed on the three-wire first lane 812 when, for example it is desired to minimize CDR circuit complexity at the receiver. In another example, transcoding may be performed on the four-wire second lane 822 in order to maximize encoding efficiency. The number of symbols used to encode a data word may be selected based on the number of signaling states provided by the transcoded lane. When the 3-wire first lane 812 is transcoded, a 4 symbol per word or a 7 symbol per word may produce desirable efficiency for encoding on the first lane 812. The second lane 822 is not transcoded and any number of symbols per word can be used to obtain optimal efficiency. In the multi-lane interface 800 of FIG. 8, a good utilization may be obtained on the second lane 822 when seven symbols per word are employed. The number of bits that can be encoded for transmission on the second lane 822 may be calculated as:

log₂(States)⁷=log₂(4!)⁷=32.0947 bits.

In some instances, the number of symbols transmitted per data word may be the same for both lanes in the multi-lane interface 800 of FIG. 8, the first lane 812 may provide a bit capacity of log₂ (3!−1)⁷=log₂=16.2535 bits for seven symbols, while the second lane 822 may provide a bit capacity of 32.0947 for seven symbols. Accordingly in a seven symbol transmission interval, 48 bits (6 bytes) may be communicated.

In some instances, the number of symbols per data word used in the first lane 812 may be different from the number of symbols per data word used in the second lane 822. In one example, maximum encoding efficiency can be obtained when different symbols per data word are used in the lanes 812, 822. A trade-off may be made between throughput and increased complexity of circuitry and processing that may result from dissociating the encoding boundaries on the lanes 812, 822 of a multi-lane interface.

As described in relation to FIGS. 6-8, significant efficiencies can be obtained when a single lane (e.g. the first lane 812 of FIG. 8) encodes clock information and other lanes 822 are encoded independently. In an example where 10 interconnects (wires or connectors) are available between two devices, a conventional 3! system may configure three 3-wire lanes, with clock information encoded on each lane. Each of the three lanes provides 5 signaling states per symbol for a total of 15 states per symbol. However, a system provided according to certain aspects described herein may use the 10 interconnects to provide two 3! lanes and one 4! lane, where the clock information is encoded in a first 3! lane. This combination of lanes provides a total of 5×6×24=720 signaling states per symbol, based on a first 3! lane providing 5 states plus clock information per symbol, a second 3! lane providing 6 states per symbol and a 4! lane providing 24 states per symbol. In another 10-interconnect example, a multi-lane interface may be configured such that the CDR extracts a clock from a 4! lane, and two additional 3! lanes are configured. In this example, the multi-lane interface can send 23×6×6=828 states per symbol, which provides increased encoding capacity than a 10-interconnect interface where the CDR extracts a clock from a 4! lane. It will be appreciated that the configuration of lanes and CDR in a multi-wire interface is typically determined based on a number of factors in addition to encoding capacity, including CDR circuit complexity, which increases with the number of connectors monitored.

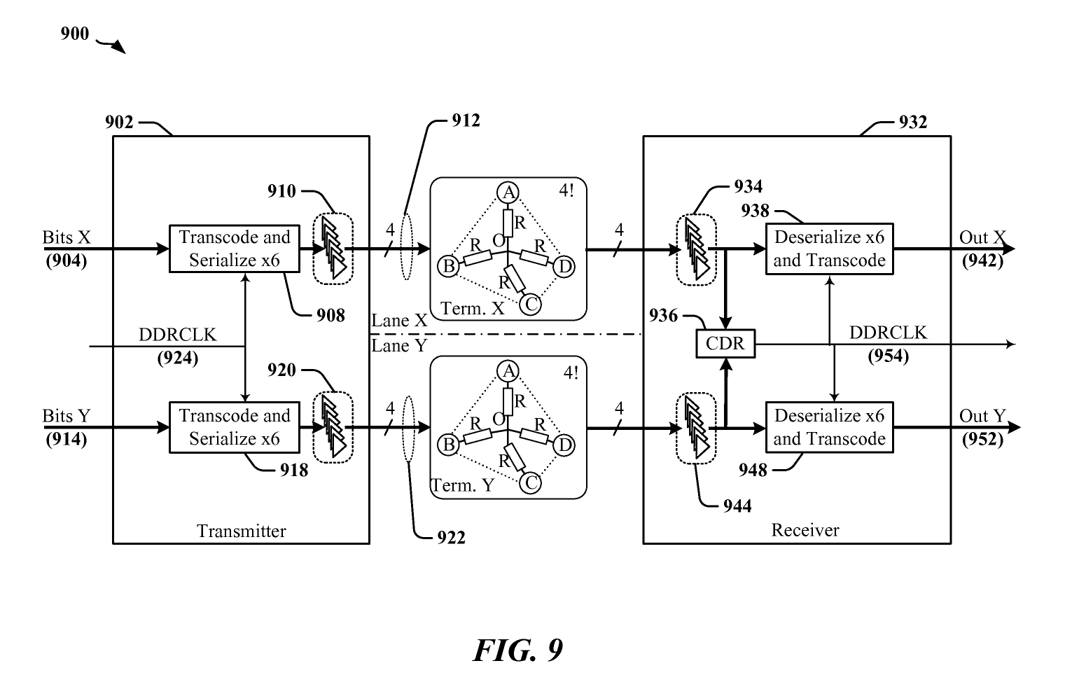

FIG. 9 illustrates another example of a multi-lane interface 900 provided in accordance with one or more aspects disclosed herein. The multi-lane interface 900 offers various benefits including improved decoding reliability, which may permit higher transmission rates. The configuration and operation of the multi-lane interface 900 in this example is similar to that of the multi-lane interface 600 of FIG. 6 or the multi-lane interface 700 of FIG. 7, except that the CDR 936 is configured to generate a receive clock 954 from transitions detected on either the first lane 912 or the second lane 922. Accordingly, the CDR 936 receives the outputs of the receivers 934 and 944. Variations in the delay between the symbol boundary and an edge of the receive clock 954 may be reduced because the CDR 936 generates a clock from the first detected transition on either lane 912, or 922. This approach can reduce the effect of variable transition times on the wires and/or variable switching times of the line drivers 910, 920 or receivers 934, 944.

In operation, data for transmission may be received in two or more portions 904 and 914, where the portions 904, 914 are for transmission on different lanes 912, 922. A combination of a transcoder and serializer circuits 908 may encode data bits X 904 and embed information related to a transmit clock 924 in a sequence of symbols to be transmitted on the first lane 912, as described in relation to FIG. 5. At the receiver 932, the outputs of both sets of receivers 934 and 944 are provided to the CDR 936, which is configured to detect a transition in signaling state on either lane 912, 922 and generate a receive clock 954 based on the transition. The receive clock 954 is used by both deserializing/transcoding circuits 938 and 948, which produce respective first and second lane data outputs 942 and 952.

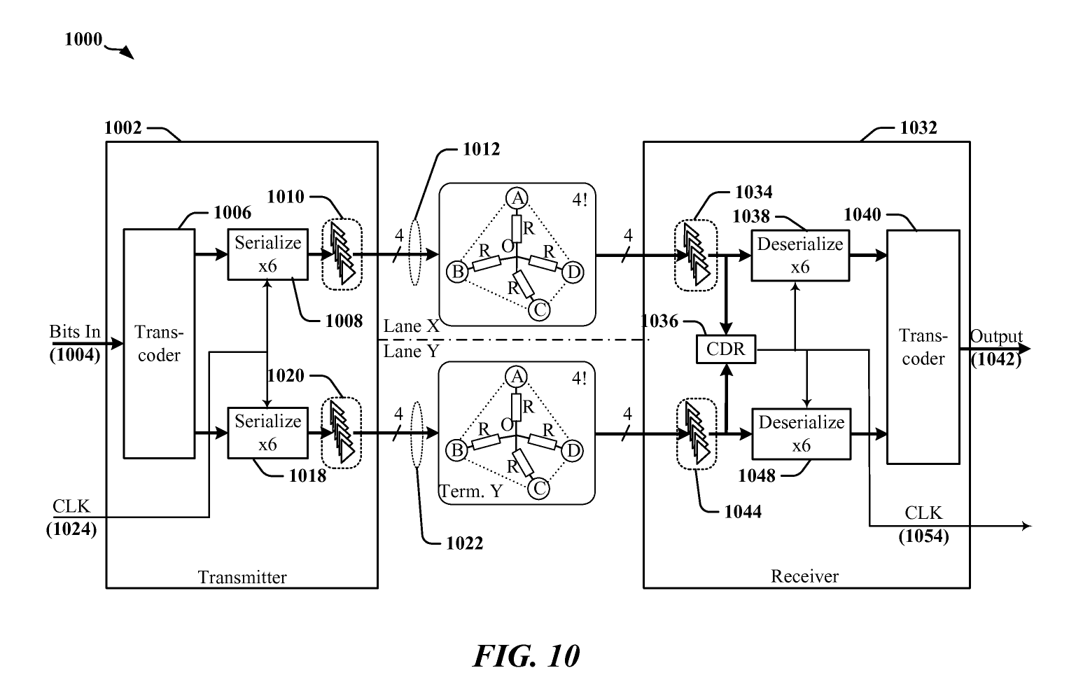

FIG. 10 illustrates another example of a multi-lane interface 1000 provided according to one or more aspects disclosed herein. In this example, the multi-lane interface 1000 offers improved data throughput and encoding efficiency by ensuring that a transition in signaling state between consecutive symbol intervals occurs on any one of a plurality of lanes 1012, 1022. Accordingly, the percentage overhead associated with encoding the clock information can be reduced relative to a system in which the clock information is embedded in sequences of symbols transmitted on a single lane. In the multi-lane interface 1000, a first lane (here Lane X) 1012 includes four wires that carry 4! encoded signals, and the second lane (here Lane Y) 1022 includes four wires and is also configured for 4! encoding. The particular example depicted in FIG. 10 is provided for illustrative purposes only, and different configurations of lanes may be employed. In one example, two or more lanes may have different numbers of wires.

A transcoder 1006 may be adapted to combine data 1004 and clock information in symbols to be transmitted over two or more lanes 1012 and/or 1022. Encoding efficiencies may be achieved by embedding clock information based on the combination of available signaling states for all lanes 1012, 1022. The clock information is embedded by ensuring that a transition in signaling state occurs on at least one lane 1012, 1022 between consecutive symbol intervals. In operation, the transcoder 1006 may be configured to produce different sets of symbols for each lane 1012, 1022. In one example, the data 1004 received by a transmitter 1002 according to a clock signal 1024 may be encoded in a first sequence of symbols encoded in the six signals transmitted on the first lane 1012, and in a second sequence of symbols encoded in the six signals transmitted on the second lane 1022 concurrently with the transmission of the first sequence of symbols. The transcoder 1006 embeds clock information by ensuring that a signaling state transition occurs on at least one of the lanes 1012 and 1022 between consecutive symbols. The total number of states per symbol interval is the product of the number of states per symbol transmitted on the first lane 1012 and the number of states per symbol transmitted on the second lane 1022. Accordingly, the number of states available to the transcoder at each symbol interval, when clock information is embedded across both lanes 1012, 1022 may be calculated as:

(Nₗₐₙₑ₁!×Nₗₐₙₑ₂!)−1=(4!×4!)−1=(24×24)−1=575.

In another example, the number of states available to the transcoder at each symbol interval, when clock information is embedded across two lanes that are encoded in three signals (using 3! encoding) may be calculated as:

(N_{laneX}!×N_{laneY}!)−1=(3!×3!)−1=(6×6)−1=35.

In another example, the number of states available to the transcoder at each symbol interval, when clock information is embedded across two lanes in which one three-wire lane is encoded in three signals (using 3! encoding) and a four-wire lane is encoded in six signals (using 4! encoding), may be calculated as:

(N_{laneX}!×N_{laneY}!)−1=(3!×4!)−1=(6×24)−1=143.

The number of states available to the transcoder at each symbol transition governs the number of bits that can be transmitted in each receive data cycle.

TABLE 1

| Bits sent in 7 symbols | Description |
|---|---|
| log₂(3! − 1)⁷ = 16.2535 | One lane 3! |
| log₂(4! − 1)⁷ = 31.6650 | One lane 4! |
| log₂((3! − 1) × 4!)⁷ = 48.3482 | 3! and 4! lanes, transcoding on 3! lane |
| log₂(3! × (4! − 1))⁷ = 49.7597 | 3! and 4! lanes, transcoding on 4! lane |
| log₂((3! × 4!) − 1)⁷ = 50.1191 | Transcoding on combined 3! and 4! lanes |
| log₂(4! × (4! − 1))⁷ = 63.7597 | Two 4! lanes, transcoding on one lane |
| log₂((4! × 4!) − 1)⁷ = 64.1719 | Transcoding on two combined 4! lanes |

Table 1 and Table 2 illustrate increased coding efficiencies when clock information is embedded by a transcoder across two or more N! lanes. Table 1 relates to the multi-lane interface 1000 of FIG. 10. As can be seen from the table, a maximum encoding efficiency is obtained when a transcoder 1006 embeds the clock information by considering the sequences of symbols transmitted on both lanes 1012, 1022.

TABLE 2

| Bits sent in 7 symbols | Description |
|---|---|
| log₂(3! − 1)⁷ × 2 = 32.5070 | Transcoding on each 3! lanes |
| log₂((3! − 1) × 3!)⁷ = 34.3482 | Transcoding on one 3! lane |
| log₂(3! × 3! − 1)⁷ = 36.1895 | Transcoding on combined 3! lanes |

Table 2 relates to an example of a multi-lane interface that has two 3! lanes.

In the example of FIG. 10, the receiver 1032 includes a CDR 1036 that generates a receive clock 1054 by detecting transitions on both lanes 1012, 1022. The deserializers 1038, 1048 provide symbols received from respective lanes 1012, 1022 to a transcoder 1040 that reverses the transcoding performed by the transcoder 1006 in the transmitter. The transcoder 1040 in the receiver 1032 operates by examining the combined sequences of received symbols to produce output data 1042, which corresponds to the data 1004 received at the transmitter 1002. Sets of line drivers 1010, 1020 and receivers 1034, 1044 may be provided according to the number of wires in the N! lanes 1012, 1022.

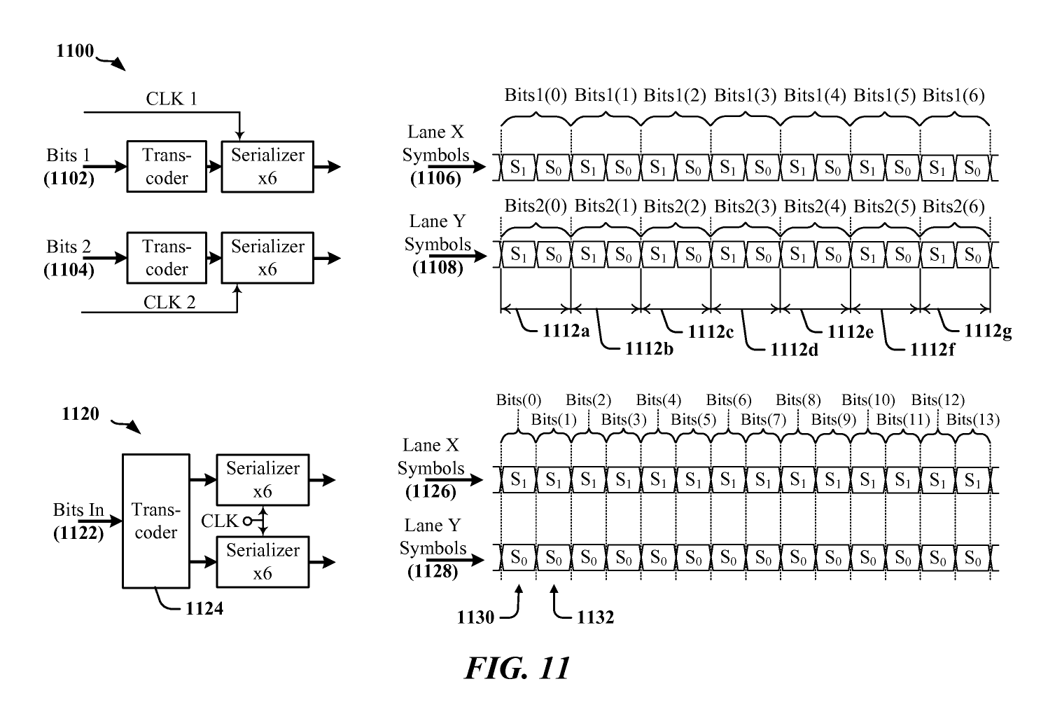

The multi-lane interface 1000 can be configured to provide additional advantages over conventional interfaces. FIG. 11 illustrates an example in which a transcoder 1124 can be used to control the order of delivery of data to a receiver. One multi-lane interface 1100 such as the multi-lane interface 1000 in FIG. 10 may independently encode two or more sets of data bits 1102, 1104 in sequences of symbols 1106, 1108 for transmission over a corresponding number of lanes. Data may be provided to the multi-lane interface 1100 pre-divided into the sets of data bits 1102, 1104, and/or the sets of data bits 1102, 1104 may be split by the multi-lane interface 1100. Data bits may be allocated among the two or more sets of data bits 1102, 1104 arbitrarily, according to function, design preference or for convenience and/or other reasons.

In the illustrated multi-lane interface 1100, each word, byte or other data element received in a first clock cycle may be encoded into two or more symbols transmitted sequentially in a pair of symbol intervals 1112a-1112g on one of the two lanes. The receiver can decode the data element when the two or more symbols are received from the pair of symbol intervals 1112a-1112g.

A multi-lane interface 1120, such as the multi-lane interface 1000 of FIG. 10, may include a transcoder 1124 that encodes data 1122 and clock information into a plurality of sequences of symbols 1126, 1128 concurrently transmitted over two or more lanes. The transcoder 1124 may control the order of delivery of data to a receiver by concurrently transmitting symbols for transmission on two lanes. In one example, data bits 1122 received in a first clock cycle (Bits(0)) may be transcoded into two symbols and transmitted in parallel on two lanes during a first symbol interval 1130. Data bits 1122 received in a second clock cycle (Bits(1)) may be transmitted as two symbols in parallel on the two lanes during a second symbol interval 1132. Transmission of data on two parallel data lanes may provide certain benefits for timing-sensitive applications such as shutter and/or flash control in a camera, control signals associated with game applications.

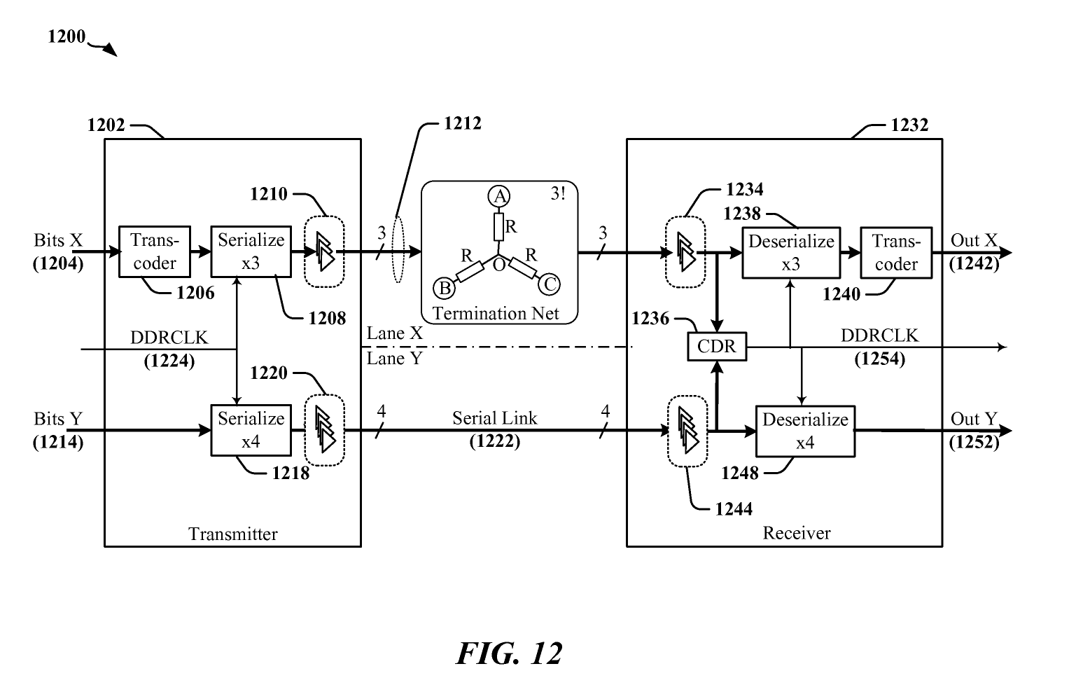

FIG. 12 illustrates another example of a multi-lane interface 1200 provided in accordance with one or more aspects disclosed herein. In this example, the multi-lane interface 1200 includes at least one N! encoded lane 1212 and a serial data link 1222. The serial data link 1222 may be a single ended serial link (as illustrated) or a differentially encoded serial data link. The serial data link 1222 may include a serial bus, such as an Inter-integrated Circuit (I2C) bus, a camera control interface (CCI) serial bus or derivatives of these serial bus technologies. In the example depicted, a clock signal 1224 is used by the serializer 1208 of the N! link and the serializer 1218 of the serial link 1222, and the clock signal 1224 need not be transmitted to the receiver 1232 over a separate clock signal lane. Instead, a transcoder 1206 embeds clock information in a sequence of symbols that is provided through the serializer to the differential line drivers of the N! lane 1212.

At the receiver 1232, a CDR 1236 generates a receiver clock signal 1254 from transitions detected at the outputs of receivers 1234. The receiver clock signal 1254 is used by the N! link deserializer 1238 and the serial link deserializer 1248. In some instances, the CDR 1236 may monitor the output of the line receivers 1244 associated with the serial link 1222 in order to improve detection of a transition between symbol intervals. The N! lane deserializer 1238 provides deserialized symbol information to the transcoder 1240, which produces output data 1242 representative of the input data 1204 that is transmitted over the N! encoded lane 1212.

In one example, a transmitter 1202 transmits symbols in three signals on a 3! encoded first lane 1212. The symbols include embedded clock information and 5 signaling states per symbol are available on the first lane 1212. The transmitter may also send data on a second lane using 4 serial signals transmitted on the wires of a serial link 1212. The receiver 1232 may generate a clock signal 1254 from the symbols transmitted on the first lane 1212, where the clock is used to decode/deserialize data transmitted on both lanes 1212, 1222. Accordingly, the serial link 1212 provides 2⁴=16 states per symbol when the clock 1254 provided by the CDR 1236 is used by the deserializer 1248 for the second lane serial link 1222. An aggregate of 5×16=80 states per symbol is achieved when the clock 1254 provided by the CDR 1236 is used.

By way of comparison, a conventional or traditional four-wire serial link 1222 may dedicate one of the four wires for carrying a clock signal, and data transmission may be limited to three signals on the other three of the 4 wires. In this latter configuration, 2³=8 signaling states per symbol may be provided on the serial link 1222, and an aggregate of 5×8=40 signaling states per symbol results when data is also transmitted in the 3! encoded first lane 1212.

In some instances, the clock rate used to control transmissions on the serial link 1222 may be scaled with respect to the differentially-encoded link 1212. For example, the clock rate for a single-ended serial link 1222 may be limited by the physical length of the serial link 1222. When the differentially-encoded link 1212 can be clocked at a faster rate than the serial link 1222, the serializer 1218 for the serial link 1222 may be provided with a different transmit clock 1224 than the transcoder 1206 and/or serializer 1208 for the differentially-encoded link 1212. Accordingly, one symbol may be transmitted on the serial link 1222 in the time period used to transmit multiple symbols on the differentially-encoded lane 1212.

Certain adaptations to the examples provided in FIGS. 6-12 may be made to further simplify circuitry in the communications interface, to improve reliability of the communications link, accommodate difference in the transmission characteristics between two or more lanes, and for other reasons. In one example, a first lane may communicate using a DDR clock having a first frequency, while a second lane may operate at a lower frequency, and/or may transmit data on one edge (rising or falling) of the DDR clock.

### CCIe Communications Links

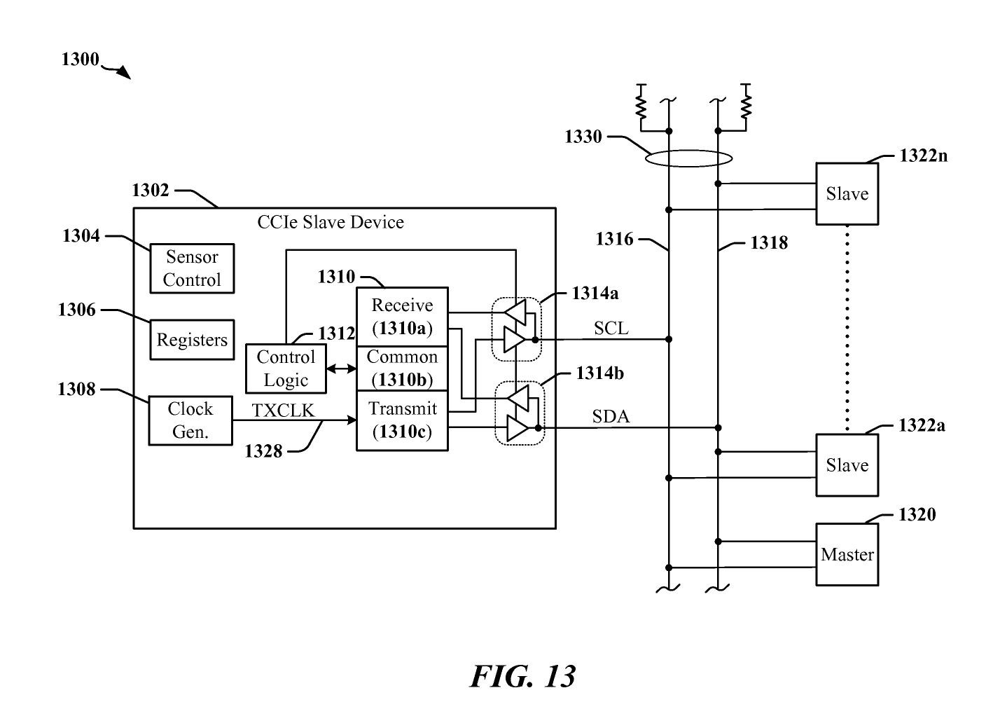

FIG. 13 is a block schematic illustrating certain aspects of an apparatus 1300 connected to a communications bus, where the apparatus may be embodied in one or more of a wireless mobile device, a mobile telephone, a mobile computing system, a wireless telephone, a notebook computer, a tablet computing device, a media player, a gaming device, a wearable computing and/or communications device, an appliance, or the like. The apparatus 1300 may include multiple devices 1302, 1310 and 1322a-1322n, which communicate using a CCIe bus 1330. The CCIe bus 1330 can extend the capabilities of a conventional CCI bus for devices that are configured for enhanced features supported by the CCIe bus 1330. For example, the CCIe bus 1330 may support a higher bit rate than a CCI bus, including bit rates of 16.7 Mbps or more.

In some instances, a multi-lane CCIe bus may be provided. The multi-lane CCIe bus may include two or more lanes, each lane providing a communications channel using a pair of wires 1330 that includes an SCL wire 1316 and an SDA wire 1318. On each lane, data may be encoded in a plurality of symbols. For simplicity of description, FIGS. 13-17 illustrate certain aspects of a single lane of a CCIe bus, although the described aspects and their associated principles may also apply to a multi-lane CCIe bus.

In the example illustrated in FIG. 13, an imaging device 1302 is configured to operate as a slave device on the CCIe bus 1330. The imaging device 1302 may be adapted to provide a sensor control function 1304 that manages an image sensor, for example. In addition, the imaging device 1302 may include configuration registers or other storage 1306, control logic 1312, a transceiver 1310 and line drivers/receivers 1314a and 1314b. The control logic 1312 may include a processing circuit such as a state machine, sequencer, signal processor or general-purpose processor. The transceiver 1310 may include a receiver 1310a, a transmitter 1310c and common circuits 1310b, including timing, logic and storage circuits and/or devices. In one example, the transmitter 1310c encodes and transmits data based on timing provided by a clock generation circuit 1308.

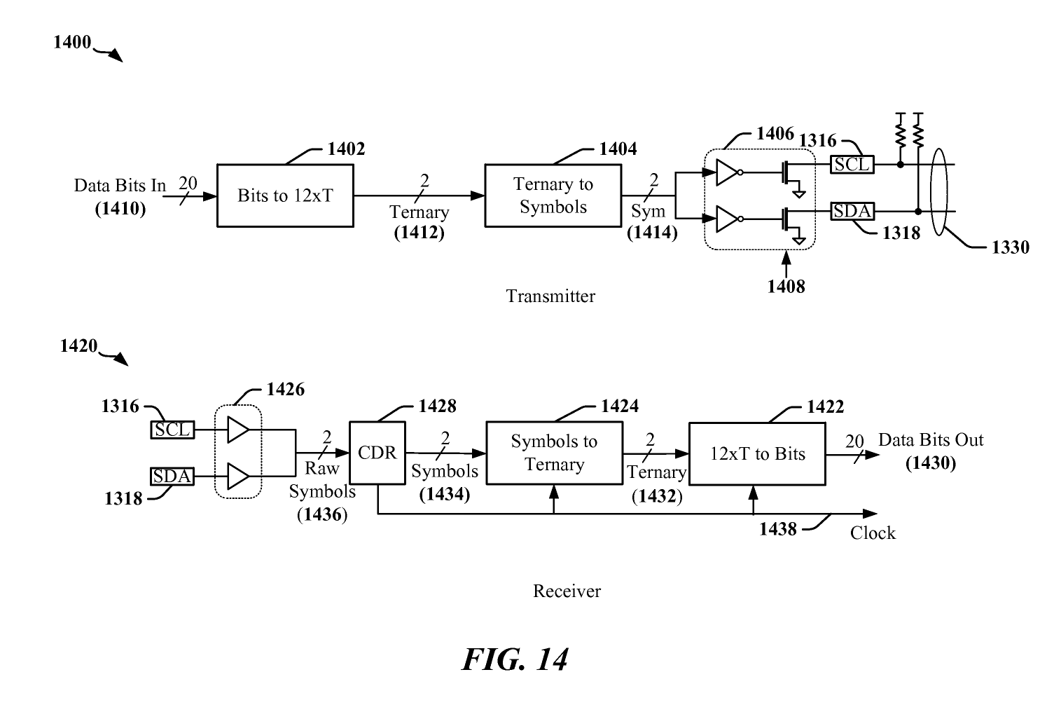

FIG. 14 is a block diagram illustrating an example of a transmitter 1400 and a receiver 1420 in a CCIe device 1302 and configured according to certain aspects disclosed herein. For CCIe operations, a transmitter 1400 coupled to a lane may transcode data 1410 into ternary (base-3) numbers, which may then be encoded as symbols transmitted on the SCL 1316 and SDA 1318 signal wires. In the example depicted, each data element (also referred to as a data word) of the input data 1410 may have 19 or 20 bits. A transcoder 1402 may receive the input data 1410 and produce a ternary number, where each digit of the ternary number represents a transition number. The ternary number may be serialized to produce a sequence 1412 of single-digit ternary transition numbers. Each digit may be encoded in two bits and there may be 12 digits in each ternary number. An encoder 1404 produces a stream of 2-bit symbols 1414 that are transmitted through line drivers 1406. In the depicted example, the line drivers 1406 includes open-drain output transistors 1408. However, in other examples, the line drivers 1406 may drive the SCL 1316 and SDA 1318 signal wires using push-pull drivers. The output stream of 2-bit symbols 1414 generated by the encoder causes a transition in the state of at least one at least one of the SCL 1316 and SDA 1318 signal wires between consecutive symbols 1414 by ensuring that no pair of consecutive symbols includes two identical symbols. The availability of a transition of state in at least one wire 1316 and/or 1318 permits a receiving circuit 1420 to extract a receive clock 1438 from the stream of data symbols 1414.

In a CCIe device, a receiver 1420 coupled to a lane may include or cooperate with a clock and data recovery (CDR) circuit 1428. The receiver 1420 may include line interface circuits 1426 that provide a stream of raw 2-bit symbols 1436 to the CDR circuit 1428. The CDR circuit 1428 extracts a receive clock 1438 from the raw symbols 1436 and may provide a stream of captured 2-bit symbols 1434 and the receive clock 1438 to other circuits 1424 and 1422 of the receiver 1420. In some examples, the CDR circuit 1428 may produce multiple clocks 1438. A decoder 1424 may use the receive clock circuit 1438 to decode the stream of symbols 1434 into sequences of 12 ternary digits 1432. The ternary digits 1432 may be encoded using two bits. A transcoder 1422 may then convert each sequence of 12 ternary digits 1432 into 19-bit or 20-bit output data elements 1430.

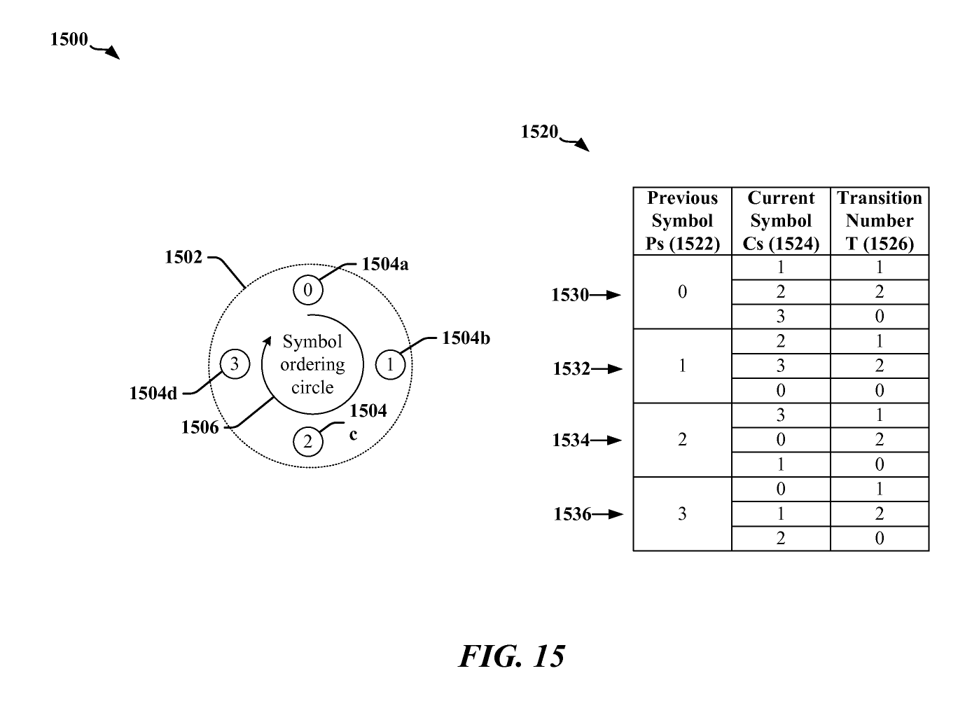

FIG. 15 is a drawing illustrating an encoding scheme 1500 that may be used by the encoder 1404 to produce a sequence of symbols 1414 with an embedded clock for transmission on the CCIe bus 1330. The encoding scheme 1500 may also be used by a decoder 1428 to extract ternary transition numbers from symbols received from the CCIe bus 1330. In the CCIe encoding scheme 1500, the two wires of the CCIe bus 1330 permit definition of 4 basic symbols S: {0, 1, 2, 3}. Any two consecutive symbols in the sequence of symbols 1414, 1434 have different states, and the symbol sequences {0, 0}, {1, 1}, {2, 2} and {3, 3} are invalid combinations of consecutive symbols. Accordingly, only 3 valid symbol transitions are available at each symbol boundary, where the symbol boundary is determined by the transmit clock and represents the point at which a first symbol (previous symbol Ps) 1522 terminates and a second symbol (current symbol Cs) 1524 begins.

According to certain aspects disclosed herein, the three available transitions are assigned a transition number (T) 1526 for each Ps symbol 1522. The value of T 1526 can be represented by a ternary number. In one example, the value of transition number 1526 is determined by assigning a symbol ordering circle 1502 for the encoding scheme. The symbol ordering circle 1502 allocates locations 1504a-1504d on the circle 1502 for the four possible symbols, and a direction of rotation 1506 between the locations 1504a-1504d. In the depicted example, the direction of rotation 1506 is clockwise. The transition number 1526 may represent the separation between the valid current symbols 1524 and the immediately preceding symbol 1522. Separation may be defined as the number of steps along the direction of rotation 1506 on the symbol ordering circle 1502 required to reach the current symbol Cs 1524 from the previous symbol 1522. The number of steps can be expressed as a single digit base-3 number. It will be appreciated that a three-step difference between symbols can be represented as a 0_{base-3}. The table 1520 in FIG. 15 summarizes an encoding scheme employing this approach.

At the transmitter 1400, the table 1520 may be used to lookup a current symbol 1524 to be transmitted, given knowledge of the previously generated symbol 1522 and an input ternary number, which is used as a transition number 1526. At the receiver 1420, the table 1520 may be used as a lookup to determine a transition number 1526 that represents the transition between the previously received symbol 1522 and the currently received symbol 1524. The transition number 1526 may be output as a ternary number.

### Clock Recovery in CCIe Communications Links

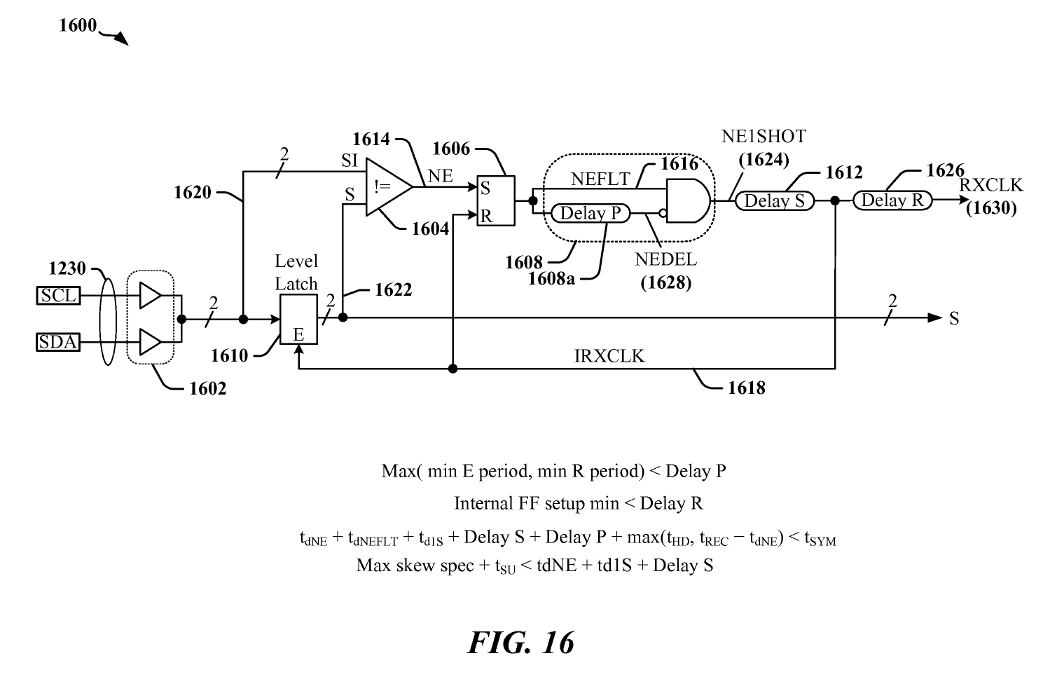

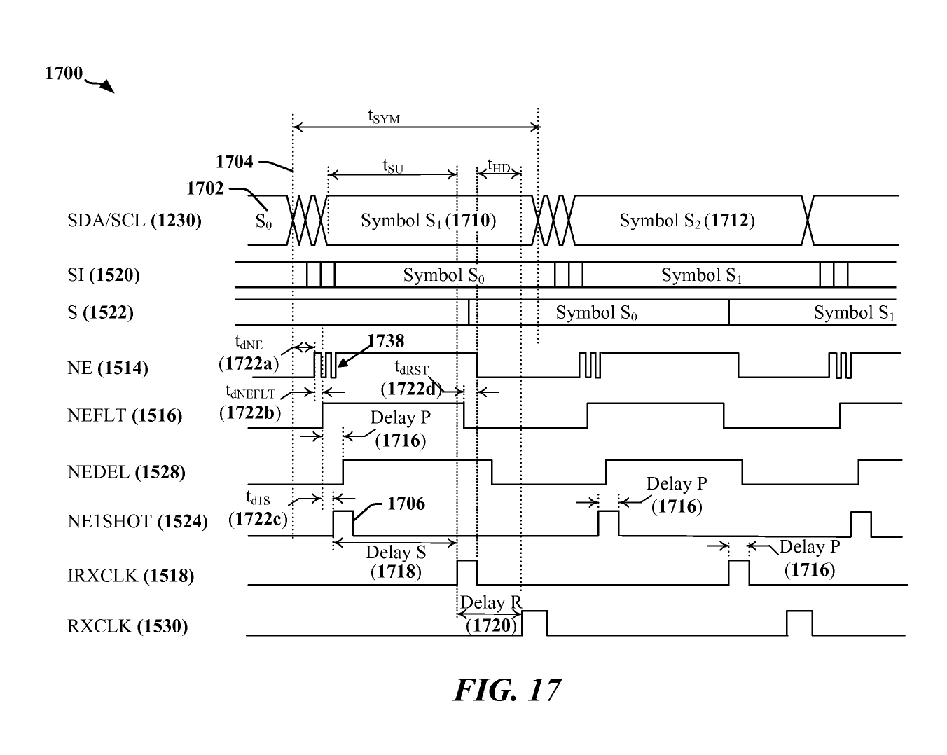

FIG. 16 illustrates an example of a CDR circuit 1600 according to one or more aspects disclosed herein and FIG. 17 shows an example of timing of certain signals generated by the CDR circuit 1600. The CDR circuit 1600 may be used in a CCIe transmission scheme where clock information is embedded in transmitted sequences of symbols. The CDR circuit 1600 may be used as the CDR 1428 depicted in FIG. 14. The CDR circuit 1600 includes analog delay elements 1608a, 1612 and 1626, which are configured to maximize set up time for symbols 1710, 1712 received from a CCIe bus 1330. The CDR circuit 1600 includes a comparator 1604, a set-reset latch 1606, a one-shot element 1608 including first delay element 1608a, a second analog delay element 1612, a third analog delay element 1626 and a level latch 1610. The comparator 1604 may compare an input signal (SI) 1620 that includes a stream of symbols 1710 and 1712 with a signal (S) 1622 that is a level-latched instance of the SI signal 1620. The comparator outputs a comparison (NE) signal 1614. The set-reset latch 1606 receives the NE signal 1614 from the comparator 1604 and outputs a filtered version (the NEFLT signal 1616) of the NE signal 1614. The first analog delay device 1608a may receive the NEFLT signal 1616 and may output a signal (the NEDEL signal 1628) that is a delayed instance of the NEFLT signal 1616. In operation, the one-shot logic 1608 receives the NEFLT signal 1616 and the NEDEL signal 1628 and outputs a signal (the NE1SHOT signal 1624) that includes a pulse 1706 that is triggered by the NEFLT signal 1616.

The second analog delay device 1612 receives the NE1SHOT signal 1624 and outputs the IRXCLK signal 1618, where the IRXCLK signal 1618 may be used to generate an output clock signal 1630 using the third analog delay element 1626. The output clock signal 1630 may be used for decoding the latched symbols in the S signal 1622. The set-reset latch 1606 may be reset based on the state of the IRXCLK signal 1618. The level latch 1610 receives the SI signal 1620 and outputs the level-latched S signal 1622, where the level latch 1610 is enabled by the IRXCLK signal 1618.

As shown in FIG. 17, a first symbol value (S₁) 1710 may cause the SI signal 1620 to commence changing its state as the first symbol is being received. The state of the SI signal 1620 may not immediately reflect a stable state corresponding to the St signal 1710 due to the possibility that intermediate or indeterminate states may occur at the signal transition from the previous symbol S₀ 1702 to the first symbol S₁ 1710 due to inter-wire skew, signal overshoot, signal undershoot, crosstalk, and so on. The NE signal 1614 transitions high when the comparator 1604 detects different value between the SI signal 1620 and the S signal 1622, causing the set-reset latch 1606 to be asynchronously set. Accordingly, the NEFLT signal 1616 transitions high, and this high state is maintained until the set-reset latch 1606 is reset when IRXCLK 1618 becomes high. The IRXCLK 1618 transitions to a high state in delayed response to the rising of the NEFLT signal 1616, where the delay is attributable in part to the analog delay element 1612.

The intermediate states on the SI signal 1620 may be regarded as invalid data and may include a short period of symbol value of the symbol S₀ 1702, and these intermediate states may cause spikes or transitions 1738 in the NE signal 1614 as the output of the comparator 1604 returns towards a low state for short periods of time. The spikes 1738 do not affect NEFLT signal 1616 output by the set-reset latch 1606, because the set-reset latch 1606 effectively blocks and/or filters out the spikes 1738 on the NE signal 1614 before outputting the NEFLT signal 1616.

The one-shot circuit 1608 outputs a high state in the NE1SHOT signal 1624 after the rising edge of the NEFLT signal 1616. The one-shot circuit 1608 maintains the NE1SHOT signal 1624 at a high state for the delay P period 1716 before the NE1SHOT signal 1624 returns to the low state. The resultant pulse 1706 on the NE1SHOT signal 1624 propagates to the IRXCLK signal 1618 after the delay S period 1718 caused by the analog delay S element 1612. The high state of the IRXCLK signal 1618 resets the set-reset latch 1606, and the NEFLT signal 1616 transitions low. The high state of IRXCLK signal 1618 also enables the level latch 1610 and the value of the SI signal 1620 is output as the S signal 1622.

The comparator 1604 detects when the S signal 1622 corresponding to the S₁ symbol 1710 matches the symbol S₁ symbol 1710 of the SI signal 1620, and the output of the comparator 1604 drives the NE signal 1614 low. The trailing edge of the pulse 1740 on the of NE1SHOT signal 1624 propagates to the IRXCLK signal 1618 after the delay S period 1718 caused by the analog delay S element 1612. When a new symbol S₂ 1712 is being received, the SI signal 1620 begins its transition to the value corresponding to the symbol S₂ 1712 after the trailing edge of the IRXCLK signal 1618.

In one example, the output clock signal 1630 is delayed by a Delay R period 1720 by the third analog delay element 1626. The output clock signal 1630 and the S signal 1622 (data) may be provided to a decoder 1424 or other circuit. The decoder 1424 may sample the symbols on the S signal 1622 using the output clock signal 1630 or a derivative signal thereof.

In the depicted example, various delays 1722a-1722d may be attributable to switching times of various circuits and/or rise times attributable to connectors. In order to provide adequate setup times for symbol capture by a decoder 1424, the timing constraint for the symbol cycle period t_{SYM} may be defined as follows:

t_{dNE}+t_{dNEFLT}+t_{dIS}+Delay S+Delay P+max(t_{HD},t_{REC}−t_{dNE})<t_{SYM}

where:
t_{sym}: one symbol cycle period,
t_{SU}: setup time of SI 1620 for the level latches 1610 referenced to the rising (leading) edge of IRXCLK 1618,
t_{HD}: hold time of SI 1620 for the level latches 1610 referenced to the falling (trailing) edge of IRXCLK 1618,
t_{dNE}: propagation delay of the comparator 1604,
t_{dRST}: reset time of the set-reset latch 1606 from the rising (leading) edge of IRXCLK 1618.

The CDR circuit 1600 employs analog delay circuits 1608a, 1612 and 1626 to ensure that a receiver 1420 may decode CCIe encoded symbols without using a high-frequency free-running system clock. Accordingly, a CCIe slave device 1302 (see FIG. 13) may be adapted to use the transmit clock 1328 as a system clock when responding to a CCIe READ command, and the CDR generated clock 1438 (which may be the RXCLK 1626) when dormant or receiving data. In one example, the transmit clock 1328 may be a double data rate (DDR) clock that has a frequency of 10 MHz. In another example, the transmit clock may be a single data rate (SDR) clock that has a frequency of 20 MHz.

In some instances, it may be necessary to provide a startup time for one or more internally generated transmit clocks 1328 (see Clock Generator circuit 1308 of FIG. 13 for example) or the CDR 1600. A slave device 1302 may stretch the START condition on the CCIe bus 1330 by manipulating signaling until the transmit clock (TXCLK) 1328 has stabilized after a CCIe read request has been received. The stretched START condition can occur before the first CCIe READ word is transmitted by the slave device 1302, after the last address word is received by the slave device 1302 (during turnaround of the CCIe bus 1330). This stretching does not impair the operation or synchronization of the CCIe bus system. Additionally or alternatively, the CCIe master 1320 may transmit dummy CCIe WRITEs if a CCIe slave 1302 needs some additional clock cycles to process data that is newly written.

In certain low-power applications, a slave device 1302 may turn on the transmit clock 1328 only during CCIe READ operations, and otherwise use a receive clock recovered by the CDR circuit 1600. For low-power operation, the slave device 1302 may operate using a received lower-frequency “heartbeat clock” during CCIe bus idle/sleep periods. According to certain aspects disclosed herein, a pulse of the heartbeat clock may be transmitted as part of a CCIe word at 30 microsecond intervals (32 kHz) such that the CCIe slave device 1302 may use the clock extracted from the heartbeat words by the CDR 1600 for standby operations.

### Multi-Lane CCIe Communications Links

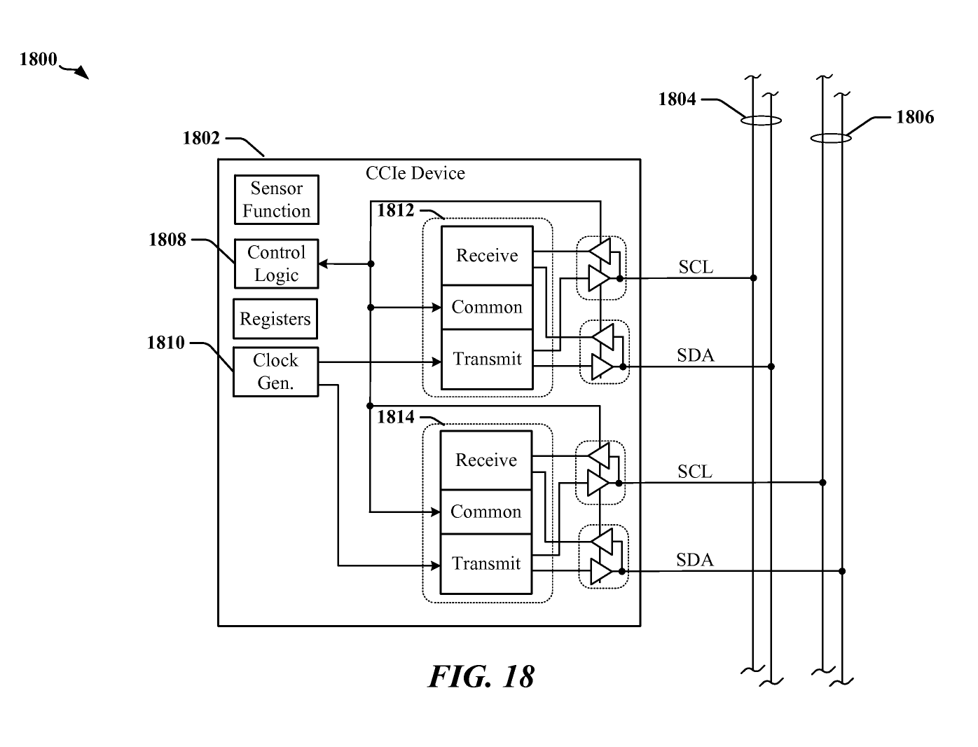

FIG. 18 is a block diagram 1800 illustrating a CCIe device 1802 that may be coupled to, and communicate using multiple lanes 1804, 1806 of a CCIe bus. The CCIe device 1802 is shown to be connected to two lanes 1804, 1806, although the CCIe device may be configurable for communication over more than two lanes. In the CCIe device 1802, communication over each lane is handled by separate transceivers 1812 and 1814, where each transceiver may correspond to the transceiver 1310 depicted in FIG. 13. Control logic 1808 may configure and control operation of the transceivers 1812 and 1814 and, as necessary to cause transmission data to be divided or multiplexed between the transceivers 1812 and 1814 for transmission on the lanes 1804, 1806 of the CCIe bus. Control logic 1808 may also configure and control operation of the transceivers 1812 and 1814 as necessary to cause data received from the transceivers 1812 and 1814 to be combined or demultiplexed. Clock generation logic 1810 may produce one or more transmit clocks that can be used by transceivers 1812 and 1814 to control rate of data transmission on the lanes 1804, 1806 of the CCIe bus. In one example, the transceivers 1812 and 1814 use a common transmit clock to control the rate of data transmission on corresponding lanes 1804 and 1806. In another example, synchronized transmit clocks are provided to the transceivers 1812 and 1814.

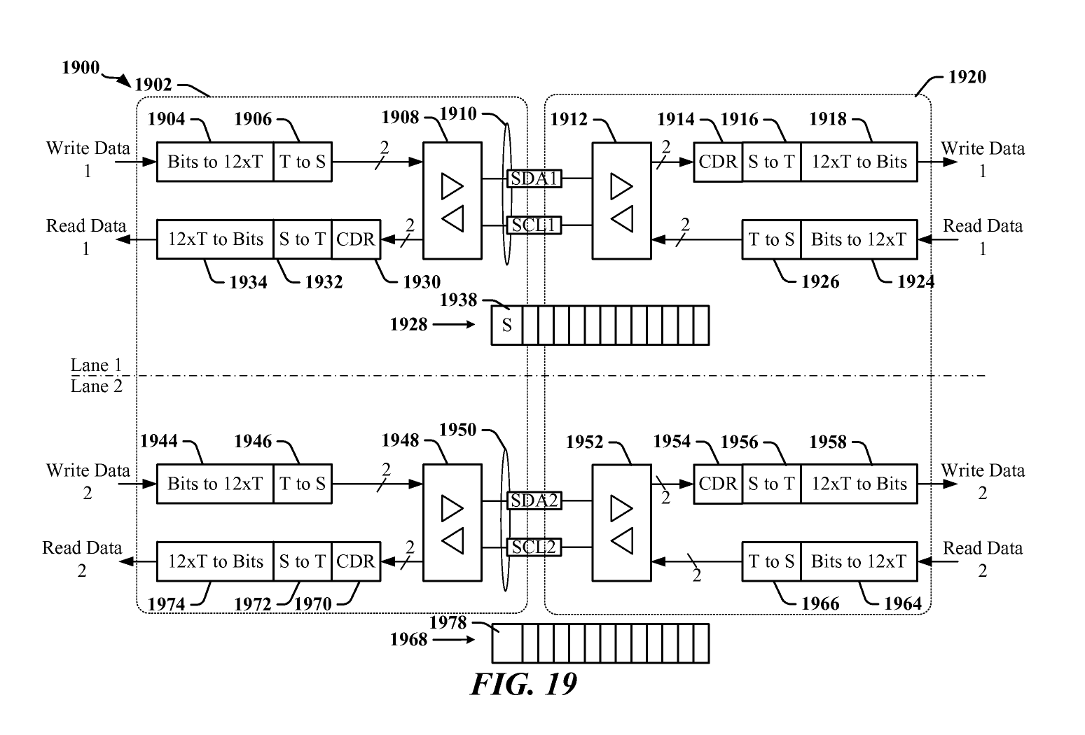

FIG. 19 is block diagram illustrating one example 1900 of a multi-lane CCIe communications link or bus connecting two devices 1902 and 1920. Bidirectional interface circuits 1908 and 1948 connect a first device 1902 to two lanes 1910 and 1950. In a second device 1920, interface circuits 1912 and 1952 provide a connection to the two lanes 1910 and 1950. In the example 1900, each of the two lanes 1910 and 1950 is implemented using some combination of electrically conductive wires, traces on a printed circuit board or substrate, or interconnects provided within or between semiconductor devices. The bidirectional interface circuits 1908, 1912, 1948 and 1952 typically include line drivers and receivers connected to each of the two connectors in a lane 1910 or 1950.

In one example, encoding logic 1944, 1946 or 1964, 1966 used for the second lane 1950 uses the same transmitter clock as the corresponding encoding logic 1904, 1906 or 1924, 1926 used for the first lane 1910. In each lane 1910, 1950, 20 bits of data may be encoded in 12 symbols for transmission on the lane 1910, 1950. Each transmission 1928, 1968 on each lane 1910, 1950 includes the 12 symbol intervals and a preceding start condition 1938, 1978. The duration of the start condition 1938, 1978 may be variable. In one example, the start condition 1938, 1978 may be communicated in the time corresponding to at least one symbol interval. The start condition 1938, 1978 may provide timing information that is used to synchronize the receive clock at the receiver.

On the first lane 1910, clock information extracted from the symbols received from the first device 1902 at the CDR 1914 of the second device 1920 may be used to extract ternary numbers from the symbols using the symbol-to-ternary converter 1916, which provides the ternary numbers to the ternary to data decoder 1918. Clock information extracted from the symbols received from the second device 1920 at the CDR 1930 of the first device 1902 may be used to extract ternary numbers from the symbols using the symbol-to-ternary converter 1932, which provides the ternary numbers to the ternary to data decoder 1934.

On the second lane 1950, clock information extracted from the symbols received from the first device 1902 at the CDR 1954 of the second device 1920 may be used to extract ternary numbers from the symbols using the symbol-to-ternary converter 1956, which provides the ternary numbers to the ternary to data decoder 1958. Clock information extracted from the symbols received from the second device 1920 at the CDR 1970 of the first device 1902 may be used to extract ternary numbers from the symbols using the symbol-to-ternary converter 1972, which provides the ternary numbers to the ternary to data decoder 1974.

In this example 1900, the receivers for first device 1902 and second device 1920 in each lane 1910 and 1950 are capable of independent operation, whereby each receiver may extract clock information from the symbols it receives in order to generate a receive clock. Such independent operation permits certain flexibility of operation for the multi-lane CCIe bus. In one example, different lanes can be operated at different clock rates. In another example, one or more lanes can be disabled or idled without affecting transmission on the other lanes of the CCIe bus.

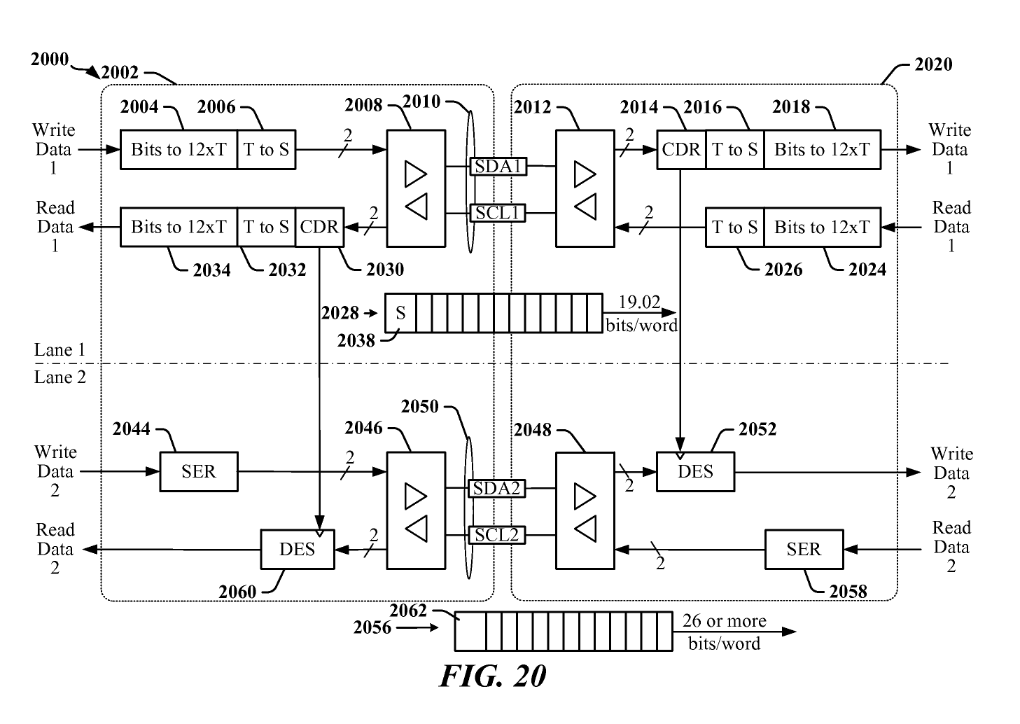

FIG. 20 is block diagram illustrating another example 2000 of a multi-lane CCIe communications bus connecting two devices 2002, 2020. Here, CDR circuits 2014 and 2050 extract timing information from the symbols transmitted on a first lane 2010 of a multi-lane CCIe bus and provide a clock signal that may be used by a plurality of lanes 2010, 2050 in the CCIe bus. In the example 2000, a clock signal generated by a CDR 2014 or 2030 is used to control timing of receive logic 2052 and 2060 on a second lane 2050 of a two lane CCIe bus. Accordingly, data may be serialized by a serializer circuit 2044, 2058 into two-bit elements for transmission on the second lane. At the receiver, the serialized data may be clocked into a deserializing circuit 2052, 2060 using the clock generated by the corresponding CDR circuit 2014, 2030 of the first lane 2010.

According to certain aspects, the second lane 2050 of the two lane CCIe bus may obtain throughput gains because serialized data transmitted on the second lane 2050 need not be preceded by a start condition and does not need to include clock information when a CDR 2014 or 2030 associated with the first lane 2010 provides a clock signal for a corresponding deserializer 2052 or 2060 used for the second lane 2050. As discussed in relation to FIG. 19, a start condition may be required to synchronize the receive clock at the receiver associated with a lane 1910, 1950, 2010 that extracts timing information from symbols transmitted on the lane 1910, 1950, 2010. For the second lane 2050 of FIG. 20, the time during which a start condition is transmitted on the first lane 2010 may be used to transmit serialized data on the second lane 2050.

In the example depicted in FIG. 20, the second lane 2050 may provide higher throughput than the first lane 2010 because serialized data is transmitted on the second lane 2050 whereas timing information is provided in a sequence of symbols transmitted on the first lane 2010. Timing information may be provided on the first lane 2010 by ensuring that the symbols in each pair of consecutive symbols are associated with different signaling states, thereby ensuring that a transition occurs after each symbol interval. For example, when four signaling states are defined, only 3 states are available for selection after each symbol interval if a transition in signaling state is to be guaranteed. In this example, a sequence of 12 symbols transmitted on the first lane 2010 may be encoded with log₂ (3¹²)=19.02 bits of data. The sequence of symbols may be transmitted in 12 symbol intervals on the first lane 2010. On the second lane 2050, two bits of serialized data may be transmitted during each of the 12 symbol intervals, thereby providing a 24 bit throughput in the same transmission interval that 19.02 bits are transmitted on the first lane 2010. Consequently, the data rate on the second lane 2050 may exceed the data rate on the first lane by approximately 26%. Additional data rate gains may be achieved if startup intervals are used to carry additional serialized data.

Bidirectional interface circuits 2008 and 2046 connect a first device 2002 to the two lanes 2010 and 2050. In a second device 2020, interface circuits 2012 and 2048 provide a connection to the two lanes 2010 and 2050. In the example 2000, each of the two lanes 2010 and 2050 is implemented using some combination of electrically conductive wires, traces on a printed circuit board or substrate, or interconnects provided within or between semiconductor devices. The bidirectional interface circuits 2008, 2012, 2046 and 2048 typically include line drivers and receivers connected to each of the two wires in a lane 2010 or 2050.

Serializing logic 2044 or 2058 used for the second lane 2050 may be controlled using the same transmitter clock as the encoding logic 2004, 2006 or 2024, 2026 used for the first lane 2010. In the first lane, 20 bits of data may be encoded in 12 symbols for transmission on the first lane 2010. Each transmission 2028, 2056 on each lane 2010, 2050 may include the 12 symbol intervals and a preceding time period used to communicate a start condition 2038 in the first lane 2010. The duration of the start condition 2038 may be variable. In one example, the start condition 2038 may be communicated in the time corresponding to at least one symbol interval. The start condition may provide timing information that is used to synchronize the receive clock at a receiver coupled to the first lane 2010.

At the CDR 2014 of the second device 2020, clock information is extracted from the symbols transmitted over the first lane 2010 by the first device 2002. The clock information may be used to generate a clock signal that can be used to extract ternary numbers from the symbols using the symbol-to-ternary convener 2016, which provides the ternary numbers to the ternary to data decoder 2018. At the CDR 2030 of the first device 2002, clock information is extracted from the symbols transmitted over the first lane 2010 by the second device 2020. The clock information may be used to generate a clock signal that can be used to extract ternary numbers from the symbols using the symbol-to-ternary converter 2032, which provides the ternary numbers to the ternary-to-data decoder 2034. With respect to the second lane 2050, deserializers 2052 and 2062 use the clock signal generated by corresponding CDR circuits 2014, 2030 associated with the first lane 2010.

The example provided in FIG. 20 can increase throughput of a multi-lane CCIe bus and reduce the complexity of the transmitter and receiver circuits of one or more lanes 2050.

### Method to Shorten CCIe Word Time

According to certain aspects disclosed herein, increased throughput may be obtained on a CCIe bus through improved signaling. In one example, the timing of signaling between consecutive sequences of symbols may be optimized by considering the signaling state of the wires of a CCIe bus. In one example, throughput improvements may be obtained by altering signaling upon entry into the interval between the consecutive sequences of symbols transmitted on a serial bus to which I2C and CCIe devices are coupled.

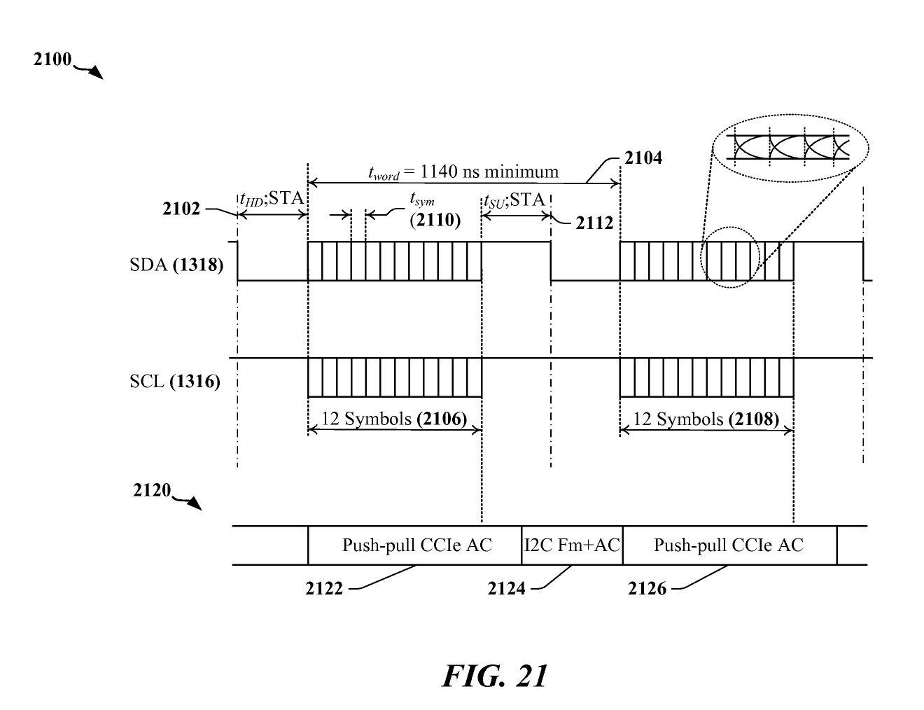

FIG. 21 is a timing diagram 2100 that illustrates data transmission on a CCIe bus 1330 (see FIG. 13) when the devices 1302, 1320, 1322a-n connected to the bus 1330 include an I2C device. In the example, CCIe devices 1302, 1320, and/or 1322a-n may use push-pull drivers 1314a, 1314b (see FIG. 14) to drive the signal wires 1318, 1316, rather than open-drain drivers 1406 (see FIG. 14), which are used by I2C devices. An effective data rate of approximately 14 megabits per second (Mbps) may be achieved for the CCIe transmission when the symbol rate is 20 MHz. As described herein, 19 bits of data may be converted to sequences of 12 symbols 2106, 2108, which control the state of the SDA signal 1318 and the SCL signal 1316 for each symbol period (t_{sym}) 2110 in the sequence of symbols 2106 or 2108. As depicted, each symbol period 2110 may have a 50 ns duration. The 19 bits may include 16 bits of data, with 3 bits of overhead.

The timing between consecutive sequences of symbols 2106 and 2108 may be dominated by time periods required to satisfy the protocols governing the operation of I2C devices. In one example, a start condition 2102 precedes each transmission 2106, 2108 and has a duration (t_{HD}) of at least 260 ns. The start condition 2102 may be defined by a symbol value of “1” such that the SDA signal 1318 is held low while the SCL signal 1316 remains high. The start condition 2102 may follow a minimum setup period (t_{SU}) 2112 when both signals 1318 and 1316 are in a high state, as defined by a symbol value of “3.” The minimum setup period (t_{SU}) 2112 may commence after a transmission 2106 or 2108 terminates, and the minimum setup period (t_{SU}) 2112 may be maintained for at least 260 ns. Accordingly, the minimum elapsed time 2104 between the start of a first transmission 2106 and the start of a second transmission 2108 may be calculated as:

t_{word}=t_{HD}+t_{SU}+12×t_{sym}=(260+260+12×(50))ns=1120 ns.

An additional, nominal 20 ns may be included for signal fall time (t_{f}) between setup and start time. The signal fall time may be calculated as:

$${t}_{f} = ( 20 \times \frac{VDD}{5.5} ) ns ( min ) , {t}_{f} = 120 ns ( max )$$

Accordingly, 19 bits of data may be transmitted in a minimum of 1140 ns, with a corresponding raw bit rate of approximately 16.7 Mbps and a useful bit rate of approximately 14.04 Mbps, since 16 bits are transmitted in the 12 symbols.

The minimum required time between the transmissions 2106 and 2108 can be significantly greater when I2C devices are accommodated on the bus 1330 than when only CCIe devices are involved in the communication. FIG. 21 includes a timing diagram 2120 that illustrates the increased time 2124 of adding I2C setup and start periods in order to provide backwards compatibility for I2C devices.

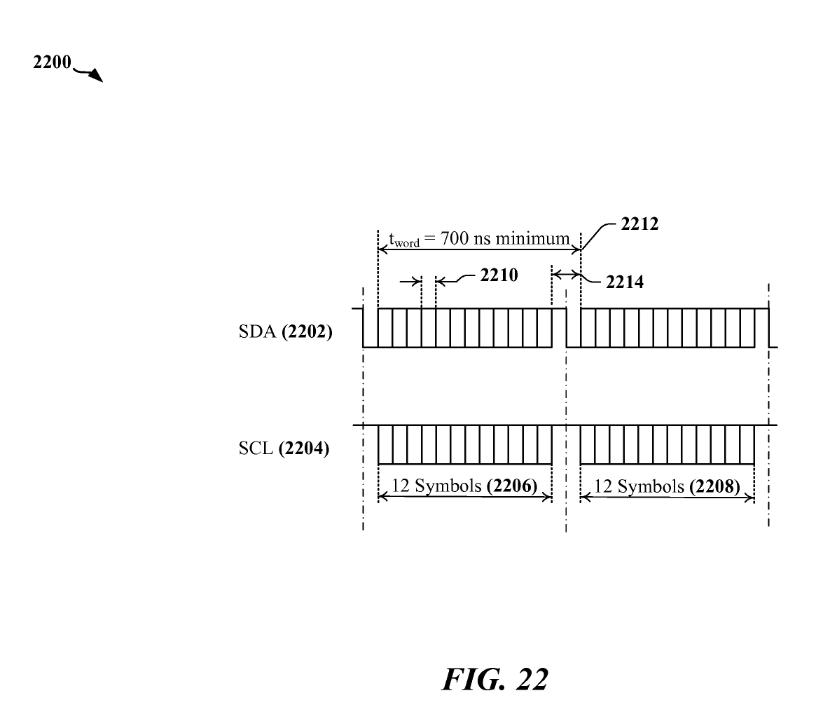

FIG. 22 is a timing diagram 2200 that illustrates data transmission on a CCIe bus 1330 when the devices 1302, 1320, 1322a-n on the bus 1330 do not include an active I2C device. In this example, push-pull drivers are used to drive the signal wires 2202, 2204. A link rate of 22.86 Mbps may be achieved with a 20 MHz symbol rate. Sequences of 12 symbols 2206, 2208 encode 16 bits of data and 3 bits of overhead. Each symbol in the sequence of 12 symbols 2206, 2208 defines the state of the SDA signal 2202 and the SCL signal 2204 for each symbol period (t_{sym}) 2210. Each symbol period 2210 may be 50 ns in duration for a 20 MHz symbol clock. The two-symbol sequence {3,1} is transmitted in the period 2214 between consecutive sequences of symbols 2206 and 2208. The minimum elapsed time 2212 between the start of a first transmission 2206 and the start of a second transmission 2208 may be calculated as:

t_{word}=14×t_{sym}=700 ns

When CCIe devices with push-pull drivers are used, 19 bits of data may be transmitted in 700 ns, providing a raw bit rate of approximately 27.1 Mbps with a useful bit rate of approximately 22.86 Mbps, since 16 data bits are transmitted in each 12 symbol word 2206, 2208.

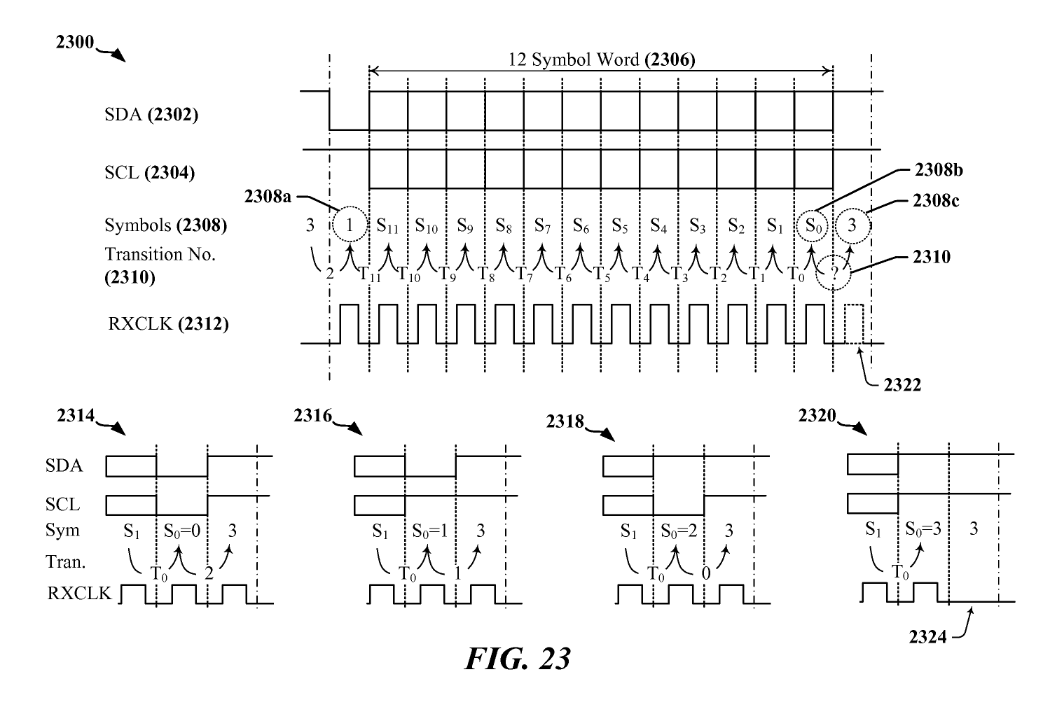

FIG. 23 includes a timing diagram 2300 illustrating certain aspects associated with the transmission of a 12-symbol word 2306. The 12-symbol word 2306 may be transmitted in a stream of symbols 2308 that includes a start symbol 2308a and a termination or setup symbol 2308c. The combination of the setup symbol 2308c and the start symbol 2308a forms a sequence of symbols {3, 1} between 12-symbol words 2306 transmitted on the CCIe bus. As described herein, any two consecutive symbols in the 12-symbol word 2306 have different states such that a receive clock 2312 may be derived from the symbol transitions. Transitions between symbols may be identified as transition numbers 2310, as described herein. A CCIe encoder may generate a sequence of 13 symbols including the transmission word 2306 and the start symbol 2308 such that transitions occur between each of the 13 symbols. However, a transition is typically not guaranteed between the last symbol 2308b of the 12-symbol word 2306 and the setup symbol 2308c, because the setup symbol 2308c has a predefined value that is unaffected by the value of the last symbol 2308b of the 12-symbol word 2306. It is possible that no transition occurs after the last symbol 2308b, and a corresponding transition number 2310 and/or associated pulse 2322 on the receive clock 2312 may not be generated as a consequence.

FIG. 23 includes timing diagrams 2314, 2316, 2318 and 2320 illustrating the effect on transitions of the four possible symbol values for the final symbol 2308b. In three examples 2314, 2316 and 2318, the value of the final symbol 2308b is not “3” and is therefore different from the value of the setup symbol 2308c. In these three examples 2314, 2316, 2318, transition numbers and pulses of the receive clock 2312 are generated. In the example 2320 where the final symbol 2308b and the setup symbol 2308c have the same value (here “3”), no transition occurs and no clock is generated in the setup interval 2324. In accordance with certain aspects described herein, CCIe throughput may be improved by taking advantage of the occasions when no transition occurs between the final symbol 2308b and the setup symbol 2308c.

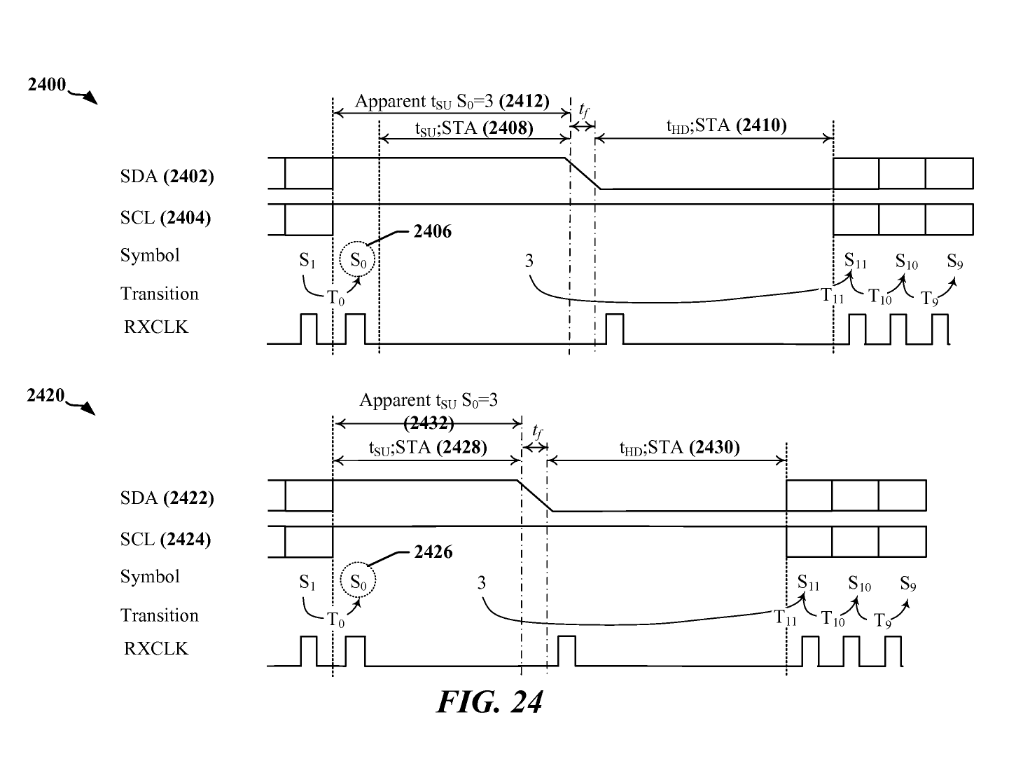

FIG. 24 illustrates an approach to improving throughput for CCIe devices by providing a setup time that includes the final symbol 2406 of a transmitted word when no transition occurs between the final symbol 2406 and the setup symbol 2308c. A pair of timing charts 2400 and 2420 illustrates an example of timing for CCIe communications when an I2C device is connected the bus although the principles described herein relate equally to communications involving only CCIe devices.

The first timing chart 2400 illustrates a first example in which a fixed length setup period 2408 is added after the final symbol 2406, regardless of the value of the final symbol 2406. In this first example, a device monitoring the signal wires 2402 and 2404 may observe an apparent setup period 2412 that has a variable length that is equal to, or greater than the minimum required setup time 2408. The second timing chart 2420 illustrates a second example where the setup timing is adjusted such that a device monitoring the signal wires 2422 and 2424 observes an apparent setup period 2432 that has a constant length equal to the minimum required setup time 2428. To provide a constant length apparent setup period 2432, the transmitter may adjust the timing of a generated setup period 2428 provided after the final symbol 2426 such that a shorter time period 2428 is added when the final symbol 2426 produces the “setup” signaling states on the signal wires 2422, 2424. To provide a constant length apparent setup period 2432, the transmitter may maintain the timing of the generated setup period 2428 and drop the final symbol 2426 when the final symbol 2406 has a value of “3.” A final symbol 2406 having a value of “3” causes both the SDA signal 2402, 2422 and the SCL signal 2404, 2424 to be in a high state.

In the first example 2400, the setup period 2412 commences at the termination of the symbol period in which final symbol S₀ 2406 is transmitted. The timing and throughput of this example 2400 may correspond to the timing and throughput discussed in relation to FIG. 21. The time to transmit a single word is constant and may be calculated as:

t_{word}=(t_{HD}+t_{f}+t_{SU})+12×t_{sym}=540+12×(50)ns=1140 ns,

yielding an effective data rate of 14.04 Mbps for a 50 ns symbol period.

In the second example 2420, a setup period 2432 that has a duration satisfying the minimum setup time specified for a bus which connects both I2C and CCIe devices may include the last transmitted symbol 2426 as part of the setup period 2432. It can be considered that any final symbol 2426 having a value of 3 is effectively dropped and that one in four final symbols 2426 can be assumed to be dropped. Accordingly, the average word size may be 11.75 symbols in length. In this example, the average time to transmit a single word may be calculated as:

t_{word}=(t_{HD}+t_{f}+t_{SU})+11.75×t_{sym}=540+11.75×50 ns=1127.5 ns,

yielding an effective data rate of 14.19 Mbps for a 50 ns symbol period.

Increased data rates may be obtained by effectively dropping the last symbol of a transmission on a CCIe bus that does need to support I2C devices, and where the CCIe devices connected to the bus use push-pull drivers. With reference again to FIG. 22, the time period 2212 for transmitting a complete word, including 12 symbols with start and stop symbols, may be calculated as:

t_{word}=(2×t_{sym})+(12×t_{sym})=2×50 ns+12×50 ns=700 ns,

yielding an effective data rate of 22.86 Mbps for a 50 ns symbol period. In this example, data rates can be increased by either dropping a final symbol 2426 that has a value of 3 or dropping the setup symbol when the final symbol 2426 has a value of 3. The net result is that the average word length may be considered to be 13.75, representing either an average 11.75 symbol payload with two symbols transmitted for setup and start conditioning, or a fixed 12 symbol payload with 1 symbols transmitted for the start condition and an average of 0.75 symbols transmitted for setup. The average time period for transmitting a word may be calculated as calculated as:

t_{word}=13.75×t_{sym}=13.75×50 ns=687.5 ns,

yielding an effective data rate of 23.27 Mbps for a 50 ns symbol period.

### Additional Descriptions of Certain Aspects of a Multi-Lane, Multi-Wire Bus

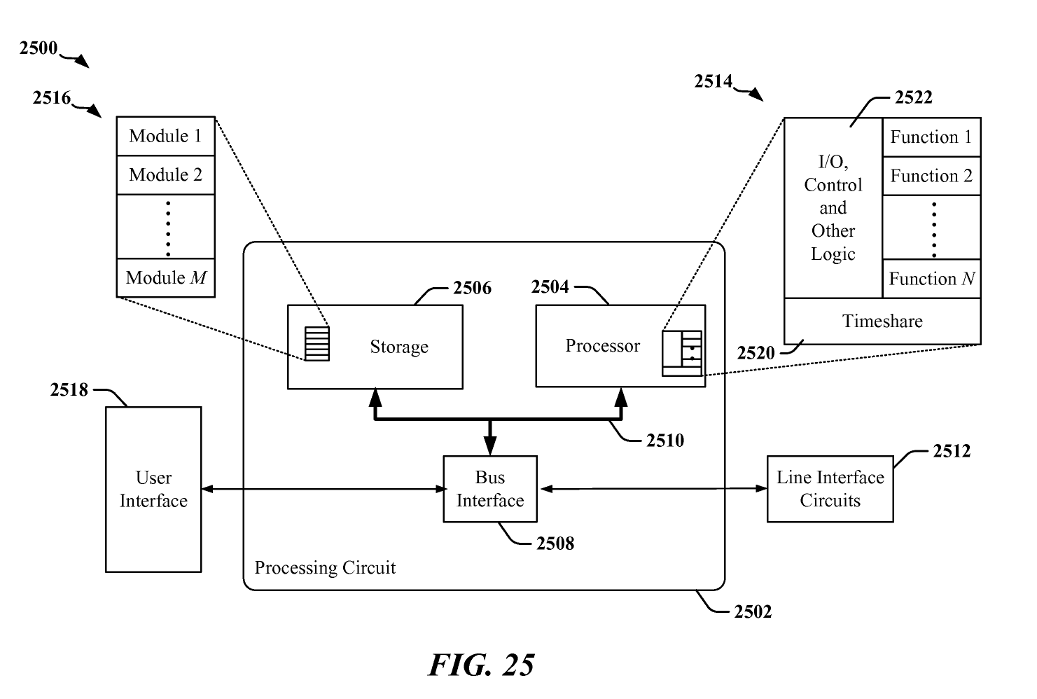

FIG. 25 is a conceptual diagram 2500 illustrating a simplified example of a hardware implementation for an apparatus employing a processing circuit 2502 that may be configured to perform one or more functions disclosed herein. In accordance with various aspects of the disclosure, an element, or any portion of an element, or any combination of elements as disclosed herein may be implemented using the processing circuit 2502. The processing circuit 2502 may include one or more processors 2504 that are controlled by some combination of hardware and software modules. Examples of processors 2504 include microprocessors, microcontrollers, digital signal processors (DSPs), field programmable gate arrays (FPGAs), programmable logic devices (PLDs), state machines, sequencers, gated logic, discrete hardware circuits, and other suitable hardware configured to perform the various functionality described throughout this disclosure. The one or more processors 2504 may include specialized processors that perform specific functions, and that may be configured, augmented or controlled by one of the software modules 2516. The one or more processors 2504 may be configured through a combination of software modules 2516 loaded during initialization, and further configured by loading or unloading one or more software modules 2516 during operation.

In the illustrated example, the processing circuit 2502 may be implemented with a bus architecture, represented generally by the bus 2510. The bus 2510 may include any number of interconnecting buses and bridges depending on the specific application of the processing circuit 2502 and the overall design constraints. The bus 2510 links together various circuits including the one or more processors 2504, and storage 2506. Storage 2506 may include memory devices and mass storage devices, and may be referred to herein as computer-readable media and/or processor-readable media. The bus 2510 may also link various other circuits such as timing sources, timers, peripherals, voltage regulators, and power management circuits. A bus interface 2508 may provide an interface between the bus 2510 and one or more line interface circuits and/or transceivers 2512. Each line interface circuit 2512 may provide a means for communicating with various other apparatus over a transmission medium, including a multi-wire interface. Depending upon the nature of the apparatus, a user interface 2518 (e.g., keypad, display, speaker, microphone, joystick) may also be provided, and may be communicatively coupled to the bus 2510 directly or through the bus interface 2508.

A processor 2504 may be responsible for managing the bus 2510 and for general processing that may include the execution of software stored in a computer-readable medium that may include the storage 2506. In this respect, the processing circuit 2502, including the processor 2504, may be used to implement any of the methods, functions and techniques disclosed herein. The storage 2506 may be used for storing data that is manipulated by the processor 2504 when executing software, and the software may be configured to implement any one of the methods disclosed herein.

One or more processors 2504 in the processing circuit 2502 may execute software. Software shall be construed broadly to mean instructions, instruction sets, code, code segments, program code, programs, subprograms, software modules, applications, software applications, software packages, routines, subroutines, objects, executables, threads of execution, procedures, functions, algorithms, etc., whether referred to as software, firmware, middleware, microcode, hardware description language, or otherwise. The software may reside in computer-readable form in the storage 2506 or in an external computer readable medium. The external computer-readable medium and/or storage 2506 may include a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a “flash drive,” a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium and/or storage 2506 may also include, by way of example, a carrier wave, a transmission line, and any other suitable medium for transmitting software and/or instructions that may be accessed and read by a computer. Computer-readable medium and/or the storage 2506 may reside in the processing circuit 2502, in the processor 2504, external to the processing circuit 2502, or be distributed across multiple entities including the processing circuit 2502. The computer-readable medium and/or storage 2506 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

The storage 2506 may maintain software maintained and/or organized in loadable code segments, modules, applications, programs, etc., which may be referred to herein as software modules 2516. Each of the software modules 2516 may include instructions and data that, when installed or loaded on the processing circuit 2502 and executed by the one or more processors 2504, contribute to a run-time image 2514 that controls the operation of the one or more processors 2504. When executed, certain instructions may cause the processing circuit 2502 to perform functions in accordance with certain methods, algorithms and processes described herein.

Some of the software modules 2516 may be loaded during initialization of the processing circuit 2502, and these software modules 2516 may configure the processing circuit 2502 to enable performance of the various functions disclosed herein. For example, some software modules 2516 may configure internal devices and/or logic circuits 2522 of the processor 2504, and may manage access to external devices such as the line interface circuits 2512, the bus interface 2508, the user interface 2518, timers, mathematical coprocessors, and so on. The software modules 2516 may include a control program and/or an operating system that interacts with interrupt handlers and device drivers, and that controls access to various resources provided by the processing circuit 2502. The resources may include memory, processing time, access to the line interface circuits 2512, the user interface 2518, and so on.

One or more processors 2504 of the processing circuit 2502 may be multifunctional, whereby some of the software modules 2516 are loaded and configured to perform different functions or different instances of the same function. The one or more processors 2504 may additionally be adapted to manage background tasks initiated in response to inputs from the user interface 2518, the line interface circuits 2512, and device drivers, for example. To support the performance of multiple functions, the one or more processors 2504 may be configured to provide a multitasking environment, whereby each of a plurality of functions is implemented as a set of tasks serviced by the one or more processors 2504 as needed or desired. In one example, the multitasking environment may be implemented using a timesharing program 2520 that passes control of a processor 2504 between different tasks, whereby each task returns control of the one or more processors 2504 to the timesharing program 2520 upon completion of any outstanding operations and/or in response to an input such as an interrupt. When a task has control of the one or more processors 2504, the processing circuit is effectively specialized for the purposes addressed by the function associated with the controlling task. The timesharing program 2520 may include an operating system, a main loop that transfers control on a round-robin basis, a function that allocates control of the one or more processors 2504 in accordance with a prioritization of the functions, and/or an interrupt driven main loop that responds to external events by providing control of the one or more processors 2504 to a handling function.

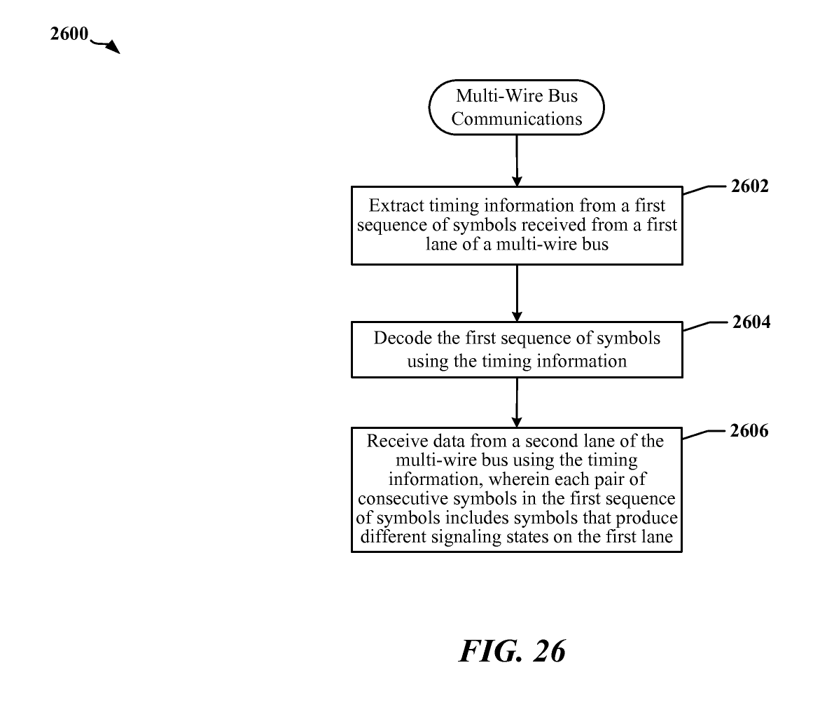

FIG. 26 includes a flowchart 2600 illustrating a method for data communications. At block 2602, timing information is extracted from a first sequence of symbols received from a first lane of a multi-wire bus. Timing information may be extracted from the first sequence of symbols received from a first lane. Each pair of consecutive symbols in the first sequence of symbols may include symbols that produce different signaling states on the first lane.

At block 2604, the first sequence of symbols is decoded using the timing information.

At block 2606, data is received from a second lane of the multi-wire bus using the timing information.

In one example, a receive clock may be generated using the timing information extracted from the first sequence of symbols. The first sequence of symbols may be decoded using the receive clock, and a bitstream received from the second lane may be deserialized using the receive clock.

In another example, transmissions received from the first and second lanes may be synchronized to a common transmit clock.

In another example, the first lane of the multi-wire bus may be operated in accordance with a CCIe mode of operation and the second lane of the multi-wire bus may be operated in accordance with a CCIe mode of operation. Receiving the data from the second lane of the multi-wire bus may include using the timing information to receive two-bit symbols from the second lane of the multi-wire bus, and decoding the two-bit symbols received from the second lane of the multi-wire bus in accordance with the timing information. The two-bit symbols received from the second lane of the multi-wire bus may include one or more symbols transmitted during a time period that indicates a start condition on the first lane. Timing information may be extracted from the symbols received from the second lane of the multi-wire bus, and a receive clock may be generated using the timing information extracted from the first sequence of symbols and the timing information extracted from the symbols received from the second lane of the multi-wire bus.

In another example, the first lane of the multi-wire bus is operated in accordance with a CCIe mode of operation, and wherein the second lane carries a serialized data stream. The data from the second lane of the multi-wire bus may be received by deserializing the serialized data stream in accordance with the timing information and to obtain a plurality of two-bit data elements, and providing the data from the second lane of the multi-wire bus by assembling the plurality of two-bit data elements. Each symbol in the first sequence of symbols may be transmitted in a symbol interval. Three signaling states per symbol interval may be available for encoding data on the first lane of the multi-wire bus. Four signaling states per symbol interval may be available for encoding data on the second lane of the multi-wire bus. The data from the second lane of the multi-wire bus may be received by receiving symbols from the second lane of the multi-wire bus using the timing information, and decoding the symbols received from the second lane of the multi-wire bus in accordance with the timing information.

In another example, the first lane of the multi-wire bus includes N wires, where N>2. N! differential signals may be provided to represent voltage differences between each different combination of two wires in the N wires, and the first sequence of symbols may be extracted from the N! differential signals based on the timing information. A first end of each of N resistance elements may be coupled to one of the N wires, and second ends of the N resistance elements may be coupled together at a common node. A receive clock may be derived from the timing information. The receive clock may be used to extract the first sequence of symbols from the N! differential signals. The first sequence of symbols may be decoded, and the receive clock may be used to deserialize data transmitted in a data stream on the second lane.

In another example, the second lane of the multi-wire bus includes M wires, where M>2, and M! differential signals are provided to represent voltage differences between each different combination of two wires in the M wires. A second sequence of symbols may be extracted from the M! differential signals based on the timing information. A first end of each of M resistance elements may be coupled to one of the M wires, and second ends of the M resistance elements may be coupled together at a common node. M can be equal to N. M and N can be unequal in value. Boundaries of data decoded from the second lane need not be aligned with boundaries of data decoded from the first lane.

In another example, the timing information may be extracted using a clock recovery circuit to derive a receive clock from transitions in signaling state detected on the multi-wire bus. First received data may be decoded from the first sequence of symbols, and second received data may be decoded from the second sequence of symbols. The first received data with the second received data may be combined to obtain output data.

In another example, the timing information may be extracted using a clock recovery circuit to derive a receive clock from transitions in signaling state detected on the first lane or the second lane. A first data word may be decoded from symbols received from a plurality of lanes in a first-occurring symbol transmission interval. A second data word may be decoded from symbols received from the plurality of lanes in a second-occurring symbol transmission interval. The receive clock may be derived using transitions in signaling state between the first-occurring symbol transmission interval and the second-occurring symbol transmission interval.

In another example, each symbol in the first sequence of symbols is transmitted in a symbol interval, N!−1 signaling states per symbol interval are available for encoding data on the first lane of the multi-wire bus, and M! signaling states per symbol interval are available for encoding data on the second lane of the multi-wire bus.

In another example, each symbol in the first sequence of symbols is transmitted in a symbol interval, and the first lane and second lane provide a combined (N!+M!−1) signaling states per symbol interval for encoding data.

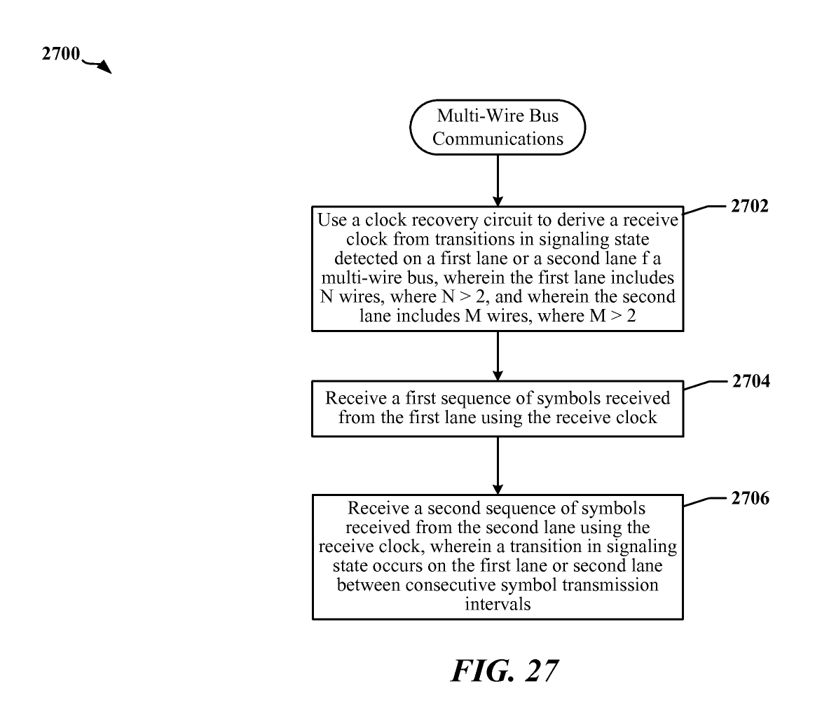

FIG. 27 is a flowchart 2700 illustrating a method for data communications. At block 2702, a clock recovery circuit may be used to derive a receive clock from transitions in signaling state detected on a first lane or a second lane of a multi-wire bus. The first lane may include N wires, where N>2. The second lane may include M wires, where M>2.

At block 2702, a first sequence of symbols may be received from the first lane using the receive clock.

At block 2702, a second sequence of symbols may be received from the second lane using the receive clock. A transition in signaling state occurs on either the first lane or the second lane between consecutive symbol transmission intervals.

In one example, first received data is decoded from the first sequence of symbols, second received data is decoded from the second sequence of symbols, and the first received data may be combined with the second received data to obtain output data.

In another example, the first sequence of symbols may be combined with the second sequence of symbols to obtain a combined sequence of symbols, and the combined sequence of symbols may be decoded to obtain output data.

In some instances, each symbol in the first sequence of symbols is transmitted in a symbol transmission interval. The first lane and second lane may provide a combined (N!+M!−1) signaling states per symbol interval for encoding data.

In some instances, a first end of each of N resistance elements is coupled to one of the N wires and second ends of the N resistance elements are coupled together at a first common node. Each of M resistance elements may be coupled to one of the M wires and second ends of the M resistance elements are coupled together at a common node.

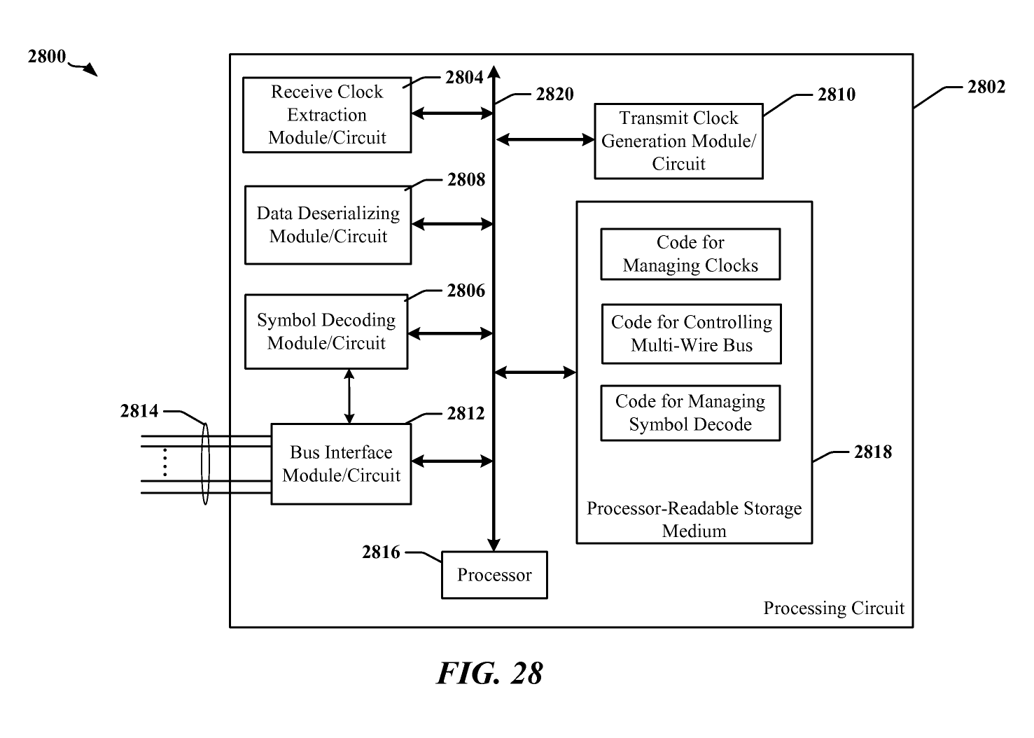

FIG. 28 is a diagram 2800 illustrating a simplified example of a hardware implementation for an apparatus employing a processing circuit 2802. The processing circuit typically has a processor 2816 that may include one or more of a microprocessor, microcontroller, digital signal processor, a sequencer and a state machine. The processing circuit 2802 may be implemented with a bus architecture, represented generally by the bus 2820. The bus 2820 may include any number of interconnecting buses and bridges depending on the specific application of the processing circuit 2802 and the overall design constraints. The bus 2820 links together various circuits including one or more processors and/or hardware modules, represented by the processor 2816, the modules or circuits 2804, 2806 and 2808, line interface circuits 2812 configurable to communicate over connectors or wires 2814 and the computer-readable storage medium 2818. The bus 2820 may also link various other circuits such as timing sources, peripherals, voltage regulators, and power management circuits, which are well known in the art, and therefore, will not be described any further.

The processor 2816 is responsible for general processing, including the execution of software stored on the computer-readable storage medium 2818. The software, when executed by the processor 2816, causes the processing circuit 2802 to perform the various functions described supra for any particular apparatus. The computer-readable storage medium 2818 may also be used for storing data that is manipulated by the processor 2816 when executing software, including data decoded from symbols transmitted over the connectors 2814, which may be configured as data lanes and clock lanes. The processing circuit 2802 further includes at least one of the modules 2804, 2806 and 2808. The modules 2804, 2806 and 2808 may be software modules running in the processor 2816, resident/stored in the computer readable storage medium 2818, one or more hardware modules coupled to the processor 2816, or some combination thereof. The modules 2804, 2806 and/or 2808 may include microcontroller instructions, state machine configuration parameters, or some combination thereof.

In one configuration, the apparatus 2800 for wireless communication includes a module and/or circuit 2804 that is configured to extract timing information and/or a receive clock from a sequence of symbols received from a first lane of a multi-wire bus 2814, a module and/or circuit 2806 that is configured to decode the sequence of symbols using the timing information, a module and/or circuit 2808 that is configured to receive data from a second lane of the multi-wire bus 2814 using the timing information, a module and/or circuit 2810 that is configured to provide a transmit clock when the multi-wire bus 2814 is in a transmission mode of operation, where the transmit clock controls transmission the first and second lanes of the multi-wire bus 2814.

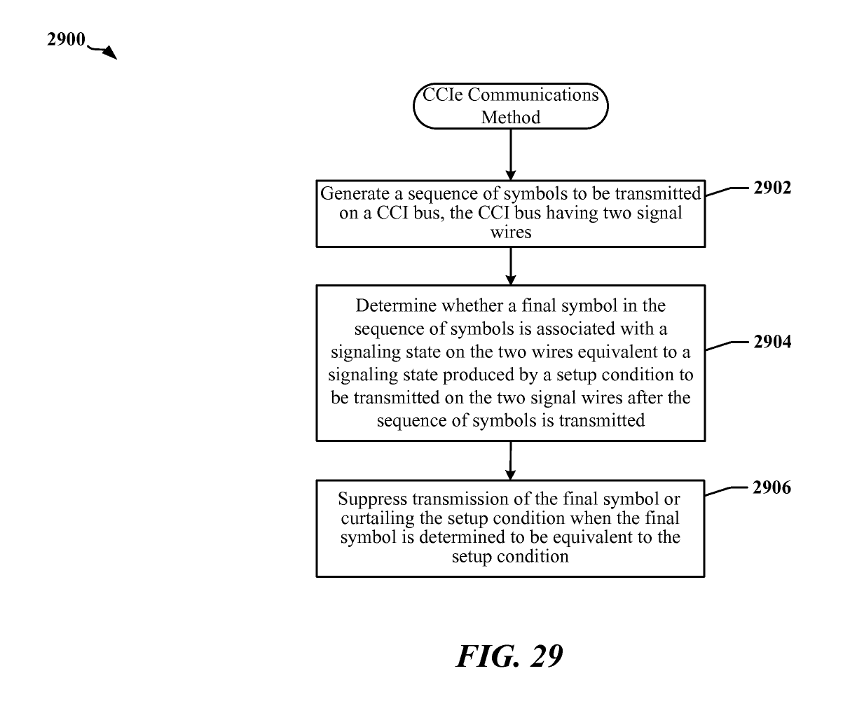

FIG. 29 includes a flowchart 2900 illustrating a method for data communications on a CCIe bus. Various steps of the method may be performed by a device that includes some combination of the CCIe slave circuit 202 illustrated in FIG. 2, the devices 300 or 320 illustrated in FIG. 3, and/or other devices described herein. At block 2902, the device may generate a sequence of symbols to be transmitted on a CCIe bus. In one example, the CCIe bus has two signal wires.

At block 2904, the device may determine whether a final symbol in the sequence of symbols is associated with a signaling state on the two wires equivalent to a signaling state produced by a setup condition. The setup condition may be transmitted on the two signal wires after the sequence of symbols is transmitted. Each of the two wires may be in a logic high state during transmission of the setup condition.

At block 2906, the device may suppress transmission of the final symbol. The device may alternatively or additionally curtail the setup condition when the final symbol is determined to be equivalent to the setup condition.

In accordance with certain aspects disclosed herein, the CCIe bus may be compatible with I2C operation. At least one I2C device may be connected to the CCIe bus. The setup condition may be transmitted for a period of time that exceeds a period of time in which the final symbol is transmitted. The at least one I2C device may be connected to the CCIe bus using open-drain transmitters.

In accordance with certain aspects disclosed herein, the setup condition may be transmitted for a period that exceeds a period of time in which the final symbol is transmitted.

In accordance with certain aspects disclosed herein, the sequence of symbols is transmitted when all of the devices monitoring the CCIe bus use push-pull transmitters when transmitting on the CCIe bus. In one example, the sequence of symbols encodes 16 bits of data. Each symbol in the sequence of symbols may be selected from four available symbols that define different signaling states of the two wires. Transmission of each symbol in the sequence of symbols causes a change in signaling state of the two wires with respect to the signaling state of the two wires prior to transmission of the each symbol. The sequence of symbols may encode protocol bits in addition to the 16 bits of data.

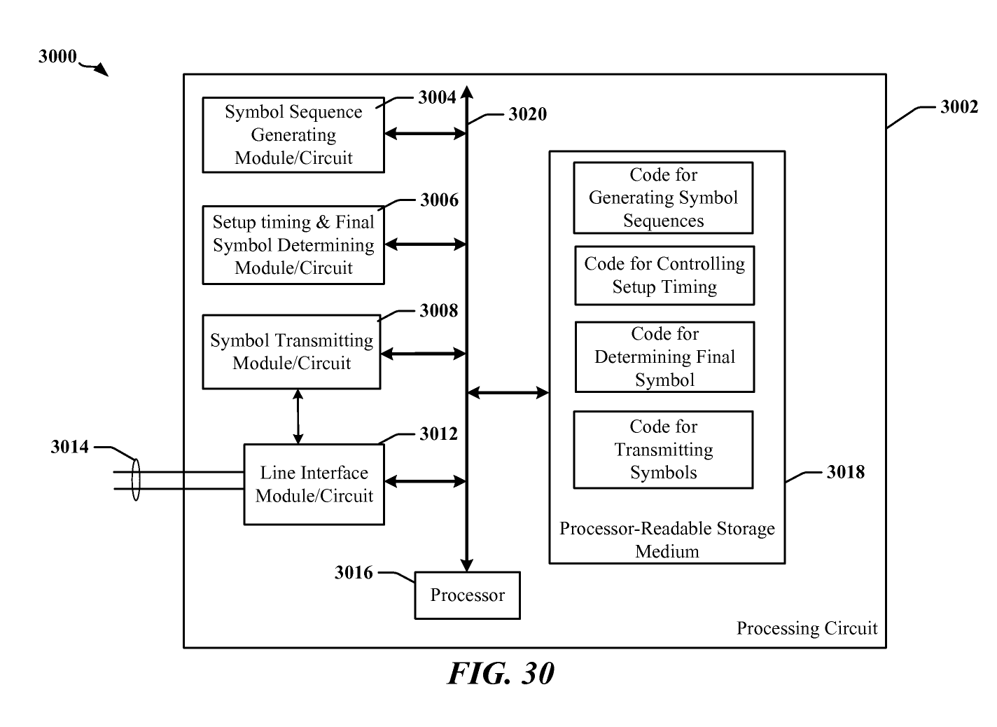

FIG. 30 is a diagram 3000 illustrating a simplified example of a hardware implementation for an apparatus employing a processing circuit 3002. The processing circuit typically has a processor 3016 that may include one or more of a microprocessor, microcontroller, digital signal processor, a sequencer and a state machine. The processing circuit 3002 may be implemented with a bus architecture, represented generally by the bus 3020. The bus 3020 may include any number of interconnecting buses and bridges depending on the specific application of the processing circuit 3002 and the overall design constraints. The bus 3020 links together various circuits including one or more processors and/or hardware modules, represented by the processor 3016, the modules or circuits 3004, 3006 and 3008, line interface circuits 3012 configurable to communicate over connectors or wires 3014 and the computer-readable storage medium 3018. The bus 3020 may also link various other circuits such as timing sources, peripherals, voltage regulators, and power management circuits, which are well known in the art, and therefore, will not be described any further.

The processor 3016 is responsible for general processing, including the execution of software stored on the computer-readable storage medium 3018. The software, when executed by the processor 3016, causes the processing circuit 3002 to perform the various functions described supra for any particular apparatus. The computer-readable storage medium 3018 may also be used for storing data that is manipulated by the processor 3016 when executing software, including data decoded from symbols transmitted over the connectors 3014, which may be configured as data lanes and clock lanes. The processing circuit 3002 further includes at least one of the modules 3004, 3006 and 3008. The modules 3004, 3006 and 3008 may be software modules running in the processor 3016, resident/stored in the computer readable storage medium 3018, one or more hardware modules coupled to the processor 3016, or some combination thereof. The modules 3004, 3006 and/or 3008 may include microcontroller instructions, state machine configuration parameters, or some combination thereof.

In one configuration, the apparatus 3000 for wireless communication includes a module and/or circuit 3004 that is configured to generate a sequence of symbols to be transmitted on the CCIe bus 3014, a module and/or circuit 3006 that is configured to determine whether a final symbol in the sequence of symbols is associated with a signaling state on the two wires equivalent to a signaling state produced by a setup condition to be transmitted on the two signal wires after the sequence of symbols is transmitted, and includes a module and/or circuit 3008 that is configured to transmit the sequence of symbols. The module and/or circuit 3008 may be configured to suppress transmission of the final symbol or curtailing the setup condition when the final symbol is determined to produce the signaling state that is equivalent to the setup condition.

The aforementioned means may be implemented, for example, using some combination of a processor or control logic 1304, 1312 and/or 1310b, physical layer drivers 1310, 1314a and 1314b and storage media 1306.

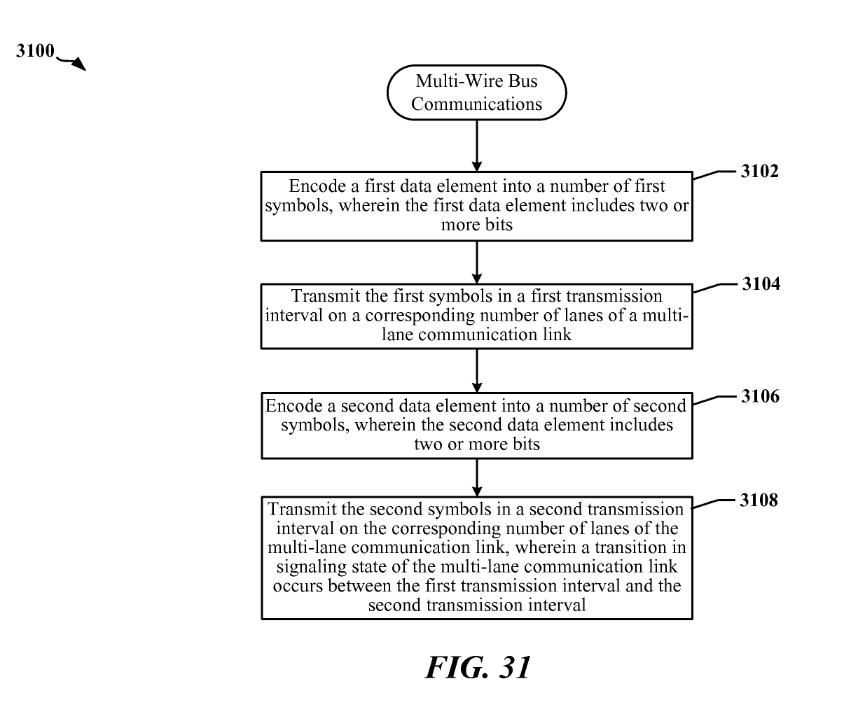

FIG. 31 includes a flowchart 3100 illustrating a method for data communications on a multi-lane communication link. The communication link may include a plurality of wires and/or connectors.

At block 3102, a first data element is encoded into a number of first symbols. The first data element may include a part or all of a data word. In one example, the data element may include two or more bits of a data word.

At block 3104, the first symbols may be transmitted during a first transmission interval on a corresponding number of lanes of the multi-lane communication link.

In one example, a first lane includes N wires, where N>2, and a second lane includes M wires, where M>2

At block 3106, a second data element is encoded into a number of second symbols. The second data element may include a part or all of a data word. In one example, the second data element may include two or more bits of a data word. In another example, the first data element and the second data element are parts of a same data word.

At block 3108, the second symbols may be transmitted in a second transmission interval on the corresponding number of lanes of the multi-lane communication link. A transition in signaling state of the multi-lane communication link occurs between the first transmission interval and the second transmission interval.

In one example, the first data element and the second data element comprise different 16-bit words, there are seven 3! lanes, and there are 7 first symbols and 7 second symbols. In another example, the first data element and the second data element comprise different 9-bit words, there are two 4! lanes, and there are 2 first symbols and 2 second symbols.

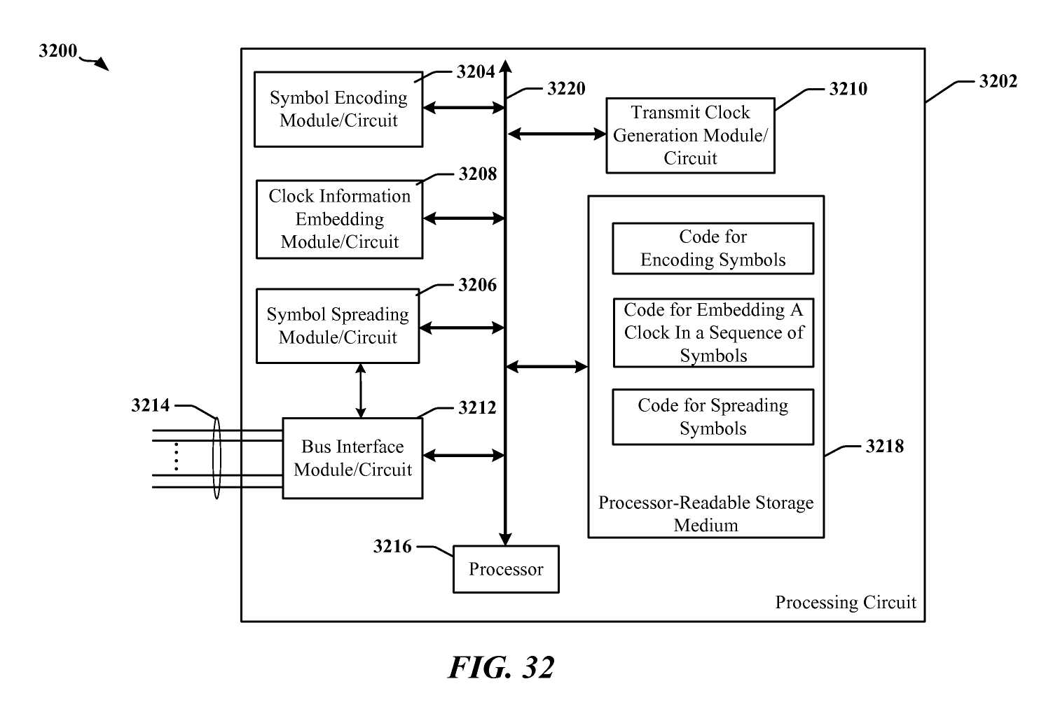

FIG. 32 is a diagram 3200 illustrating a simplified example of a hardware implementation for an apparatus employing a processing circuit 3202. The processing circuit typically has a processor 3216 that may include one or more of a microprocessor, microcontroller, digital signal processor, a sequencer and a state machine. The processing circuit 3202 may be implemented with a bus architecture, represented generally by the bus 3220. The bus 3220 may include any number of interconnecting buses and bridges depending on the specific application of the processing circuit 3202 and the overall design constraints. The bus 3220 links together various circuits including one or more processors and/or hardware modules, represented by the processor 3216, the modules or circuits 3204, 3206 and 3208, line interface circuits 3212 configurable to communicate over connectors or wires 3214 and the computer-readable storage medium 3218. The bus 3220 may also link various other circuits such as timing sources, peripherals, voltage regulators, and power management circuits, which are well known in the art, and therefore, will not be described any further.

The processor 3216 is responsible for general processing, including the execution of software stored on the computer-readable storage medium 3218. The software, when executed by the processor 3216, causes the processing circuit 3202 to perform the various functions described supra for any particular apparatus. The computer-readable storage medium 3218 may also be used for storing data that is manipulated by the processor 3216 when executing software, including data decoded from symbols transmitted over the connectors 3214, which may be configured as data lanes and clock lanes. The processing circuit 3202 further includes at least one of the modules 3204, 3206 and 3208. The modules 3204, 3206 and 3208 may be software modules running in the processor 3216, resident/stored in the computer readable storage medium 3218, one or more hardware modules coupled to the processor 3216, or some combination thereof. The modules 3204, 3206 and/or 3208 may include microcontroller instructions, state machine configuration parameters, or some combination thereof.

In one configuration, the apparatus 3200 for wireless communication includes a module and/or circuit 3204 that is configured to encode data into symbols to be concurrently transmitted on a plurality of lanes of a multi-wire bus 3214, a module and/or circuit 3206 that is configured to embed timing information (e.g. transmit clock) into a sequence of symbols to be transmitted on one or more lanes of the multi-wire bus 3214, and a module and/or circuit 3208 that is configured to spread the symbols across a plurality of lanes for transmission during the same symbol transmission interval.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A method of data communications, comprising:
extracting timing information from a first sequence of symbols received from a first lane of a multi-wire bus;
decoding the first sequence of symbols using the timing information; and
receiving data from a second lane of the multi-wire bus using the timing information,
wherein each pair of consecutive symbols in the first sequence of symbols includes symbols that produce different signaling states on the first lane.

2. The method of claim 1, further comprising:
generating a receive clock using the timing information extracted from the first sequence of symbols;
decoding the first sequence of symbols using the receive clock; and
deserializing a bitstream received from the second lane using the receive clock.

3. The method of claim 1, wherein transmissions received from the first and second lanes are synchronized to a common transmit clock.

4. The method of claim 1, wherein symbol transitions occur on both edges of a clock that has rising edges and falling edges, and wherein data received from the second lane transitions at one type of edge.

5. The method of claim 1, wherein the first lane of the multi-wire bus is operated in accordance with a camera control interface (CCIe) mode of operation and the second lane of the multi-wire bus is operated in accordance with a CCIe mode of operation, and wherein receiving the data from the second lane of the multi-wire bus comprises:
using the timing information to receive two-bit symbols from the second lane of the multi-wire bus; and
decoding the two-bit symbols received from the second lane of the multi-wire bus in accordance with the timing information.

6. The method of claim 5, wherein the two-bit symbols received from the second lane of the multi-wire bus include one or more symbols transmitted during a time period that indicates a start condition on the first lane.

7. The method of claim 5, further comprising:
extracting timing information from the symbols received from the second lane of the multi-wire bus; and
generating a receive clock using the timing information extracted from the first sequence of symbols and the timing information extracted from the symbols received from the second lane of the multi-wire bus.

8. The method of claim 1, wherein the first lane of the multi-wire bus is operated in accordance with a CCIe mode of operation, and wherein the second lane carries a serialized data stream.

9. The method of claim 8, wherein receiving the data from the second lane of the multi-wire bus comprises:
deserializing the serialized data stream in accordance with the timing information and to obtain a plurality of two-bit data elements; and
providing the data from the second lane of the multi-wire bus by assembling the plurality of two-bit data elements.

10. The method of claim 8, wherein:
each symbol in the first sequence of symbols is transmitted in a symbol interval;
3 signaling states per symbol interval are available for encoding data on the first lane of the multi-wire bus; and
4 signaling states per symbol interval are available for encoding data on the second lane of the multi-wire bus:

11. The method of claim 8, wherein receiving the data from the second lane of the multi-wire bus comprises:
using the timing information to receive symbols from the second lane of the multi-wire bus; and
decoding the symbols received from the second lane of the multi-wire bus in accordance with the timing information.

12. The method of claim 1, wherein the first lane of the multi-wire bus includes N wires, where N>2, and further comprising:
providing N! differential signals that are representative of voltage differences between each different combination of two wires in the N wires; and
extracting the first sequence of symbols from the N! differential signals based on the timing information,
wherein a first end of each of N resistance elements is coupled to one of the N wires and second ends of the N resistance elements are coupled together at a common node.

13. The method of claim 12, further comprising:
deriving a receive clock based on the timing information, the receive clock being used to extract the first sequence of symbols from the N! differential signals;
decoding the first sequence of symbols; and
deserializing a bitstream received from the second lane using the receive clock
using the receive clock to deserialize data in a serial data stream transmitted on the second lane.

14. The method of claim 12, wherein the second lane of the multi-wire bus includes M wires, where M>2, and further comprising:
providing M! differential signals that are representative of voltage differences between each different combination of two wires in the M wires; and
extracting a second sequence of symbols from the M! differential signals based on the timing information,
wherein a first end of each of M resistance elements is coupled to one of the M wires and second ends of the M resistance elements are coupled together at a common node.

15. The method of claim 14, wherein M is not equal to N.

16. The method of claim 14, wherein boundaries of data decoded from the second lane are not aligned with boundaries of data decoded from the first lane.

17. The method of claim 14, wherein:
each symbol in the first sequence of symbols is transmitted in a symbol interval;
N!−1 signaling states per symbol interval are available for encoding data on the first lane of the multi-wire bus; and
M! signaling states per symbol interval are available for encoding data on the second lane of the multi-wire bus.

18. A method of data communications, comprising:
using a clock recovery circuit to derive a receive clock from transitions in signaling state detected on a first lane or a second lane of a multi-wire bus, wherein the first lane includes N wires, where N>2, and wherein the second lane includes M wires, where M>2;
receiving a first sequence of symbols from the first lane using the receive clock; and
receiving a second sequence of symbols from the second lane using the receive clock,
wherein a transition in signaling state occurs on the first lane or the second lane between consecutive symbol transmission intervals.

19. The method of claim 18, further comprising:
decoding first received data from the first sequence of symbols;
decoding second received data from the second sequence of symbols; and
combining the first received data with the second received data to obtain output data.

20. The method of claim 18, further comprising:
combining the first sequence of symbols with the second sequence of symbols to obtain a combined sequence of symbols; and
decoding the combined sequence of symbols to obtain output data.

21. The method of claim 18, further comprising:
decoding a first data word from symbols received from a plurality of lanes in a first symbol transmission interval.

22. The method of claim 18, wherein each symbol in the first sequence of symbols is transmitted in a symbol transmission interval, and wherein the first lane and second lane provide a combined (N!+M!−1) signaling states per symbol interval for encoding data.

23. The method of claim 18, wherein a first end of each of N resistance elements is coupled to one of the N wires and second ends of the N resistance elements are coupled together at a first common node, and wherein each of M resistance elements is coupled to one of the M wires and second ends of the M resistance elements are coupled together at a common node.

24. An apparatus, comprising:
a clock recovery circuit configured to generate a receive clock from transitions in signaling state detected on a plurality of connectors of a multi-lane bus;
first receiving circuitry adapted to decode first symbols received from a first lane of the multi-lane bus using the receive clock;
second receiving circuitry adapted to decode second symbols received from a second lane of the multi-lane bus using the receive clock, or to deserialize data transmitted on the second lane of the multi-lane bus using the receive clock; and
a decoder adapted to provide output data by decoding a sequence of symbols received from one or more lanes of the multi-lane bus,
wherein each pair of consecutive symbols in the sequence of symbols includes symbols that produce different signaling states on the multi-lane bus.

25. The apparatus of claim 24, wherein the clock recovery circuit is configured to:
generate the receive clock from transitions in signaling state detected on one or more lanes of the multi-lane bus.

26. The apparatus of claim 24, wherein the first lane of the multi-lane bus is operated in accordance with a camera control interface (CCIe) mode of operation and wherein the second lane carries a serialized data stream.

27. The apparatus of claim 26, further comprising:
a deserializer adapted to convert a plurality of two-bit data elements in the serialized data stream to data words of a predefined size.

28. The apparatus of claim 27, wherein the plurality of two-bit data elements received from the second lane of the multi-lane bus include one or more two-bit data elements transmitted during a time period that indicates a start condition on the first lane.

29. The apparatus of claim 24, wherein the first lane of the multi-lane bus includes N connectors, where N>2, and further comprising:
N! differential receivers that provide N! differential signals representative of voltage differences between each possible combination of two connectors in the N connectors of the first lane, wherein the first symbols are extracted from the N! differential signals based on the receive clock,
wherein a first end of each of N resistance elements is coupled to one of the N connectors and second ends of the N resistance elements are coupled together at a common node.

30. The apparatus of claim 29, further comprising:
a data recovery circuit configured to extract the first symbols from the N! differential signals using the receive clock; and
a transcoder adapted to decode first-lane data from the first symbols.

31. The apparatus of claim 29, wherein the second lane of the multi-lane bus includes M connectors, where M>2, and further comprising:
M! differential receivers that provide M! differential signals representative of voltage differences between each possible combination of two connectors in the M connectors of the second lane, wherein the second symbols are extracted from the M! differential signals based on the receive clock, and
wherein a first end of each of M resistance elements is coupled to one of the M connectors and second ends of the M resistance elements are coupled together at a common node.

32. The apparatus of claim 31, wherein M is not equal to N.

33. The apparatus of claim 31, wherein boundaries of data decoded from the second lane are not aligned with boundaries of data decoded from the first lane.

34. The apparatus of claim 31, wherein the clock recovery circuit is configured to derive the receive clock from transitions in signaling state detected on the first lane or the second lane, and further comprising:
a first data recovery circuit configured to extract the first symbols from the N! differential signals using the receive clock;
a second data recovery circuit configured to extract the second symbols from the M! differential signals using the receive clock;
a first transcoder adapted to decode first-lane data from the first symbols; and
a second transcoder adapted to decode second-lane data from the second symbols,
wherein the first-lane data and the second-lane data are combined to provide output data.

35. The apparatus of claim 31, wherein the clock recovery circuit is configured to derive the receive clock from transitions in signaling state detected on the first lane or the second lane, and further comprising:
a first data recovery circuit configured to extract the first symbols from the N! differential signals using the receive clock;
a second data recovery circuit configured to extract the second symbols from the M! differential signals using the receive clock; and
a transcoder adapted to decode output data from a combination of the first symbols and the second symbols.

36. A method of data communications, comprising:
generating a sequence of symbols to be transmitted on a camera control interface (CCIe) bus, the CCIe bus having two signal wires;
determining whether a final symbol in the sequence of symbols is associated with a signaling state on the two wires that is equivalent to a signaling state produced by a setup condition to be transmitted on the two signal wires after the sequence of symbols is transmitted; and
suppressing transmission of the final symbol or curtailing the setup condition when the final symbol is determined to produce the signaling state that is equivalent to the setup condition.

37. The method of claim 36, wherein each of the two wires is in a logic high state during transmission of the setup condition.

38. The method of claim 36, wherein the CCIe bus is compatible with Inter-Integrated Circuit (I2C) operation and at least one I2C device is connected to the CCIe bus, and wherein the setup condition is transmitted for a period of time that exceeds a period of time in which the final symbol is transmitted.

39. The method of claim 38, wherein the at least one I2C device is connected to the CCIe bus using open-drain transmitters.

40. The method of claim 36, wherein the setup condition is transmitted for a period that exceeds a period of time in which the final symbol is transmitted.

41. The method of claim 36, wherein the setup condition is transmitted for one symbol interval and wherein transmission of the setup condition is suppressed.

42. The method of claim 41, wherein the sequence of symbols is transmitted when all devices monitoring the CCIe bus use push-pull transmitters when transmitting on the CCIe bus.

43. The method of claim 36, wherein the sequence of symbols encodes 16 bits of data, and wherein each symbol in the sequence of symbols defines one of four different signaling states associated with the two wires.

44. The method of claim 43, wherein transmission of each symbol in the sequence of symbols causes a change in signaling state of the two wires with respect to the signaling state of the two wires prior to transmission of the each symbol.

45. The method of claim 43, wherein the sequence of symbols encodes 3 protocol bits in addition to the 16 bits of data.

46. An apparatus, comprising:
a plurality of drivers configured for driving a camera control interface (CCIe) bus; and
a processing circuit configured to:
generate a sequence of symbols to be transmitted on the CCIe bus, wherein the CCIe bus comprises two signal wires;
determine whether a final symbol in the sequence of symbols is associated with a signaling state on the two wires that is equivalent to a signaling state produced by a setup condition to be transmitted on the two signal wires after the sequence of symbols is transmitted; and
suppress transmission of the final symbol or curtailing the setup condition when the final symbol is determined to produce the signaling state that is equivalent to the setup condition.

47. The apparatus of claim 46, wherein each of the two wires is in a logic high state during transmission of the setup condition.

48. The apparatus of claim 46, wherein the CCIe bus is compatible with Inter-Integrated Circuit (I2C) operation and at least one I2C device is connected to the CCIe bus, and wherein the setup condition is transmitted for a period of time that exceeds a period of time in which the final symbol is transmitted.

49. The apparatus of claim 48, wherein the at least one I2C device is connected to the CCIe bus using open-drain transmitters.

50. The apparatus of claim 46, wherein the setup condition is transmitted for a period that exceeds a period of time in which the final symbol is transmitted.

51. The apparatus of claim 46, wherein the setup condition is transmitted for one symbol interval and wherein transmission of the setup condition is suppressed.

52. The apparatus of claim 51, wherein the sequence of symbols is transmitted when all devices monitoring the CCIe bus use push-pull transmitters when transmitting on the CCIe bus.

53. The apparatus of claim 46, wherein the sequence of symbols encodes 16 bits of data, and wherein each symbol in the sequence of symbols is one of four available symbols that define different signaling states of the two wires.

54. The apparatus of claim 53, wherein transmission of each symbol in the sequence of symbols causes a change in signaling state of the two wires with respect to the signaling state of the two wires prior to transmission of the each symbol.

55. The apparatus of claim 53, wherein the sequence of symbols encodes 3 protocol bits in addition to the 16 bits of data.

56. A method of data communications, comprising:
encoding a first data element into a number of first symbols, wherein the first data element includes two or more bits;
transmitting the first symbols in a first transmission interval on a corresponding number of lanes of a multi-lane communication link;
encoding a second data element into a number of second symbols, wherein the second data element includes two or more bits;
transmitting the second symbols in a second transmission interval on the corresponding number of lanes of the multi-lane communication link,
wherein a transition in signaling state of the multi-lane communication link occurs between the first transmission interval and the second transmission interval.

57. The method of claim 56, wherein a first lane of the multi-lane communication link includes N wires, where N>2, and wherein a second lane of the multi-lane communication link includes M wires, where M>2.

58. The method of claim 56, wherein the first data element and the second data element are parts of a same data word.

59. The method of claim 56, wherein the first data element and the second data element comprise different 16-bit words, there are 7 three-wire lanes, and there are 7 first symbols and 7 second symbols.

60. The method of claim 56, wherein the first data element and the second data element comprise different 9-bit words, there are 2 four-wire lanes, and there are 2 first symbols and 2 second symbols.
